(19) United States
(12) Patent Application Publication
(10) Pub. No.: US 2010/0197815 A1
(43) Pub. Date: Aug. 5, 2010

(54) Polyparaphenylene Hydrocarbon Electrolyte, Manufacture Method Therefor, and Polyparaphenylene as well as Electrolyte Membrane, Catalyst Layer and Solid Polymer Fuel Cell

(75) Inventors: Naohiro Hoshikawa, Aichi-gun (JP); Naoki Hasegawa, Kasugai-shi (JP); Masaya Kawasumi, Anjyo-shi (JP); Yoshifumi Aoki, Aichi-gun (JP); Masayoshi Takami, Hamamatsu-shi (JP); Mitsuyasu Kawahara, Susono-shi (JP)

Correspondence Address: OLIFF & BERRIDGE, PLC, P.O. BOX 320850, ALEXANDRIA, VA, 22320-4850, US

(73) Assignee: Toyota Jidosha Kabushiki Kaisha, Toyota-shi (JP)

(21) Appl. No.: 12/225,239

(22) PCT Filed: Mar. 28, 2007
(86) PCT No.: PCT/IB2007/000801

§ 371 Date: Sep. 29, 2008

(30) Foreign Application Priority Data
Mar. 29, 2006 (JP) 2006-090951
Feb. 15, 2007 (JP) 2007-034296

(51) Int. Cl. B01J 39/18

(52) U.S. Cl. 521/25

(57) ABSTRACT

A polyparaphenylene hydrocarbon electrolyte having a structure represented by a formula (1), a manufacture method therefore, and a polyparaphenylene usable as a raw material for manufacturing the polyparaphenylene hydrocarbon electrolyte, as well as a electrolyte membrane, a catalyst layer and a solid polymer fuel cell that employ the polyparaphenylene hydrocarbon-based electrolyte. In the formula, A is an integer of (1) or greater; B is an integer of 0 or greater; and C is an integer of 1 to 10. X represents a direct bond or an oxygen atom, which is arbitrarily assignable in repetitions. At least one of Y₁s represents a proton-conducting site, and the rest of Y₁s each represent a hydrogen atom or a proton-conducting site, which is arbitrarily assignable in repetitions. The proton-conducting site is made up of —SO₃H, —COOH, —PO₃H₂ or —SO₂NHSO₂R (R is an alkyl chain or a perfluoroalkyl chain).

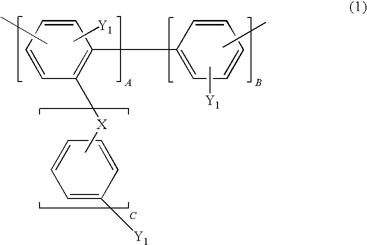

### FIELD OF THE INVENTION

The invention relates to a polyparaphenylene hydrocarbon electrolyte, and a manufacture method therefor, and polyparaphenylene as well as an electrolyte membrane, a catalyst layer and a solid polymer fuel cell employing a polyparaphenylene hydrocarbon electrolyte. More particularly, the invention relates to a polyparaphenylene hydrocarbon electrolyte in which aromatic rings are linked to one another via direct bonds or via —O— bonds, and the swelling in planar direction is small when a membrane is formed, and a polyparaphenylene that can be used as a starting material for manufacturing the polyparaphenylene hydrocarbon electrolyte, as well as an electrolyte membrane, a catalyst layer and a solid polymer fuel cell that employ a polyparaphenylene hydrocarbon electrolyte.

### BACKGROUND OF THE INVENTION

The solid polymer fuel cell is made up of basic units of a membrane-electrode assembly (MEA) in which electrodes are joined to both surfaces of a solid polymer electrolyte membrane. Furthermore, in the solid polymer fuel cell, the electrode generally has a two-layer structure of a diffusion layer and a catalyst layer. The diffusion layer is provided for supplying a reaction gas and electrons, and is often a carbon paper, a carbon cloth, etc. The catalyst layer is a portion that becomes a reaction place of the electrode reaction, and is generally made up of a composite of a carbon that supports an electrode catalyst, such as platinum or the like, and a solid polymer electrolyte (catalyst layer-contained electrolyte).

It is a general practice to use, as the electrolyte membrane or the catalyst layer-contained electrolyte that constitutes the MEA, a fluorocarbon-based electrolyte excellent in oxidation resistance (e.g., Nafion (registered trademark, by DuPont), Aciplex (registered trademark, by Asahi Kasei), Flemion (registered trademark, by Asahi Glass), etc.). However, the fluorocarbon-based electrolyte is excellent in oxidation resistance, but is generally very expensive. Therefore, in order to reduce the cost of solid polymer fuel cells, the use of a hydrocarbon-based electrolyte is also considered.

For example, JP-A-2004-010631 describes a proton conductive high-molecular compound obtained by:

(1) synthesizing a sulfonated polyether sulfone by sulfonating polyether sulfone (—C₆H₄—SO₂—C₆H₄—O—) with concentrated sulfuric acid and chlorosulfonic acid;
(2) synthesizing polyether sulfone that has phenolic hydroxyl groups, by heating the sulfonated polyether sulfone, sodium hydroxide and potassium hydroxide at 300° C. under nitrogen stream; and
(3) causing the polyether sulfone having phenolic hydroxyl groups with 1,4-butane sultone so that a proton-conductive substituent group (OCH₂CH₂CH₂CH₂SO₃H) is introduced into an aromatic ring. The aforementioned literature states that a high-molecular compound with a proton-conductive substituent group introduced into an aromatic group improves in oxidation resistance, as compared with sulfonated polyether sulfone.

WO96/39455 discloses a polymerization method for not a solid polymer electrolyte but an aromatic compound, including the steps of:

(1) dissolving anhydrous nickel chloride, sodium iodide, tri(2-methylphenyl)phosphite, and 2,5-dichlorobenzophenone (Cl₂C₆H₃—CO—C₆H₅) in N-methylpyrrolidone (NMP); and
(2) adding an activated zinc dust into the solution, and causing reaction at 90° C. for 36 hours to polymerize 2,5-dichlorobenzophenone. This literature states that the use of such a method allows reduction of the cost of coupling polymerization of the aromatic compound.

Furthermore, JP-A-2002-289222 discloses a proton-conductive high-molecular compound in which a sulfonic acid group is bound to a polymer main chain via a spacer.

Furthermore, Macromolecules 2005, 38, 5010-5016, discloses a solid polymer electrolyte that has a structure in which the main chain and the side chains are all linked by phenyl groups, and the para-structure contained in the main chain accounts for 75%.

JP-A-2005-248143 discloses a polyparaphenylene sulfonic acid obtained by:

(1) adding potassium 2,5-dichlorobenzene sulfonate and a ligand (2,2′-bipyridyl), and raising the temperature of the mixture to 80° C.;
(2) adding a condensation agent (bis(1,5-cyclo-Octagen)nickel (O)) into the solution, and stirring the mixture at 80° C. for 5 hours; and
(3) filtering the resultant black polymer and washing the material with HCl aqueous solution.

This literature states that if the monomers and the condensation agent are caused to act at a temperature of 45° C. or higher, a high-molecular compound whose molecular weight of 5×10⁴.

Acta Polymer., 44, 59-69 (1993), and J. Polym. Sci. Part A: Polym. Chem., 39, 1533-1544 (2001) show as an example, a polyparaphenylene (PPP), not a solid polymer electrolyte, that has various side chains that have been synthesized through the use of a Pd catalyst. This literature describes that introduction of flexible alkyl chains into monomers makes it possible to synthesize a polyparaphenylene of a higher molecular weight. Furthermore, Tetrahedron Letters, 44, 1541-1544 (2003), describes that in a reaction by a transition metal complex of a low-molecular compound, not a high-molecular compound, a subsidiary reaction occurs due to the coordination of oxygen to the Pd catalyst (oxidation).

Furthermore, JP-A-2005-320523 discloses a polyarylene-based polymer electrolyte obtained by copolymerizing a bifunctional monomer having a hydrophilic group (e.g., sodium 3-(2,5-dichlorophenoxy)propane sulfonate, and the like), and a hydrophobic bifunctional monomer (e.g., 2,5-dichlorobenzophenone, a chloro-terminal type polyether sulfone, etc.).

Furthermore, JP-A-2006-179301 discloses a polymer electrolyte membrane obtained by:

(1) irradiating a polyvinylidene fluoride film with γ rays;
(2) placing this film into a 40-wt % monomer (vinyl toluene/t-butyl styrene/bis-vinylphenylethane) solution diluted with toluene for multiple co-graft polymerization; and
(3) providing a graft polymerization membrane with a crosslinked structure by γ-ray irradiation. This literature describes that if the high-molecular film containing graft molecular chains is provided with a crosslinked structure due to γ-rays, crosslinking can be formed regarding the film, and the graft molecular chains as well, and therefore the oxidation resistance improves.

During the power generation of the fuel cell, hydrogen peroxide is produced due to the subsidiary reaction of the electrode reaction. Hydrogen peroxide decomposes to hydroxyl radicals under an environment in which transition metal ions whose valence changes coexist. Since the hydroxyl radical is highly oxidative, the hydroxyl radical degrades not only the hydrocarbon-based electrolyte but also a fluorine-based electrolyte with high oxidation resistance. As of now, it is difficult to restrain the production of hydrogen peroxide at the time of power generation of the fuel cell. Therefore, in order to reduce the cost of the fuel cell and heighten the durability thereof, it is essential to develop a hydrocarbon-based electrolyte that is excellent in oxidation resistance.

However, the hydrocarbon-based electrolyte disclosed in JP-A-2004-010631 contains —SO₂— bonds in the main chain, and therefore is low in the chemical stability with respect to the hydroxyl radical. Likewise, the high-molecular compound disclosed in WO96/39455 contains —CO— bonds in its side chains, and therefore is low in the chemical resistance to the hydroxyl radical. Therefore, even if protonic acid groups are introduced into side chains, the ion conversion capacity drops due to detachment of side chains. JP-A-2002-289222 does not give any description or the regarding what structure is chemical stable.

Furthermore, the solid polymer electrolyte generally needs water in order to manifest its proton conductivity. Therefore, ordinarily, the electrolyte membrane is used in a water-containing state. However, during a stop of power generation or the like, the electrolyte membrane may sometimes become dry. Generally, the electrolyte membrane swells in planar direction of the membrane when in the water-containing state, and shrinks in the dry state. Therefore, if a fuel cell incorporating an electrolyte membrane that swells greatly in the planar direction in the water-containing state is repeatedly subjected to wet-dry cycles, stress occurs in the membrane, and causes cracks of the membrane, and the like. The crack of the membrane causes gas leakage, and therefore a problem in the power generation. Therefore, in order to improve the durability of the fuel cell, it is necessary to restrain the swelling of the electrolyte membrane in the planar direction thereof.

However, there has been no proposal of a hydrocarbon-based electrolyte that provides a membrane whose swelling in the planar direction is small. Furthermore, JP-A-2002-289222 does not give any description or the like what structure provides the least swelling in the planar direction.

Furthermore, in order to restrain the membrane cracks and the like despite repeatedly performed wet-dry cycles, it is necessary to use an electrolyte membrane whose mechanical strength is high. To that ends, larger molecular weights of the electrolyte is preferable. Among the hydrocarbon-based electrolytes, electrolytes based on polyparaphenylene are characterized in that the heat resistance is high. However, in the case of a synthesis method for an ordinary polyparaphenylene that does not have polar groups, the resultant polymers precipitates during the polymerization, so that the molecular weight of the product does not increase. Therefore, polyparaphenylene generally has a problem of being brittle since the polymer is rigid.

Furthermore, the solubility of the polyparaphenylene in an ordinary organic solvent dramatically decreases as the length of the polyparaphenylene increases. Therefore, it is generally difficult to synthesize a polyparaphenylene of high molecular weight. For solving this problem, there are known a method in which side chains made up of long-chain alkyl groups or polar substituent groups are introduced into the polymer so that affinity to the polymerization solvent is provided (see Acta Polymer., 44, 59-69 (1993); and J. Polym. Sci., Part A: Polym. Chem., 39, 1533-1544 (2001)), and a method in which the polymerization is performed at a temperature that does not inhibit the polymerization reaction, through the utilization of the characteristic that the solubility of the polymer rises with rises in the temperature (see JP-A-2005-248143).

Furthermore, the polymer electrolyte generally improves in the electrical conductivity as the ion exchange capacity enlarges. Along with such changes, the water content thereof also increases, which is a property of the polymer electrolyte. As the water content becomes high, the swelling of the membrane increases. Eventually, the permeation pressure becomes unbearably high, thus causing destruction or dissolution of the membrane. On the other hand, if a polymer electrolyte with small ion exchange capacity is used, these problems can be solved. However, the electric conductivity becomes small, giving rise to a problem that the use of the electrolyte membrane in a fuel cell becomes impossible. Therefore, if the ion exchange capacity of the polymer electrolyte is reduced to make the electrolyte hydrophobic, the polymer electrolyte cannot be used as a fuel cell-purpose electrolyte membrane that needs to have high performance.

Known methods for making a polymer electrolyte insoluble are a method in which a hydrophilic-hydrophobic-block polymer is synthesized, and a method in which a crosslink structure is introduced through the use of a crosslinking agent or radiation. However, both the method of synthesizing the hydrophilic-hydrophobic block copolymer and the method of introducing a chemical crosslink require at least two process steps, and are disadvantageous in terms of cost. Furthermore, the method of introducing a crosslink structure through the use of radiation not only needs a special device, but also partially destroys the polymer, thus leading to the risk of reduction of the mechanical strength of the membrane.

### DISCLOSURE OF THE INVENTION

It is an object of the invention to provide a polyparaphenylene hydrocarbon electrolyte excellent in chemical durability, a manufacture method therefor, and a polyparaphenylene that is usable as a starting material for manufacturing the foregoing polyparaphenylene hydrocarbon electrolyte, as well as an electrolyte membrane, a catalyst layer and a solid polymer fuel cell that employ the polyparaphenylene hydrocarbon electrolyte.

It is another object of the invention to provide a polyparaphenylene hydrocarbon electrolyte that makes a membrane whose swelling in planar direction thereof is small, a manufacture method therefor, and a polyparaphenylene that is usable as a starting material for manufacturing the foregoing polyparaphenylene hydrocarbon electrolyte, as well as an electrolyte membrane, a catalyst layer and a solid polymer fuel cell that employ the polyparaphenylene hydrocarbon electrolyte.

It is still another object of the invention to provide a polyparaphenylene hydrocarbon electrolyte whose molecular weight is relatively large and whose flexibility is relatively high, a manufacture method therefor, and a polyparaphenylene that is usable as a starting material for manufacturing the foregoing polyparaphenylene hydrocarbon electrolyte, as well as an electrolyte membrane, a catalyst layer and a solid polymer fuel cell that employ the polyparaphenylene hydrocarbon electrolyte.

It is yet another object of the invention to provide a polyparaphenylene hydrocarbon electrolyte whose electric conductivity is high and whose swelling resistance is high, a manufacture method therefor, and a polyparaphenylene that is usable as a starting material for manufacturing the foregoing polyparaphenylene hydrocarbon electrolyte, as well as an electrolyte membrane, a catalyst layer and a solid polymer fuel cell that employ the polyparaphenylene hydrocarbon electrolyte.

A first aspect of the invention relates to a polyparaphenylene hydrocarbon-based electrolyte having a structure represented by the following formula (1):

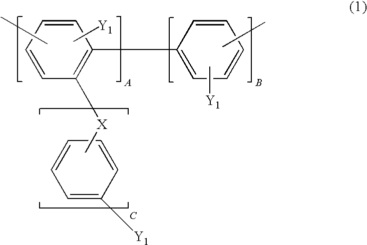

In the formula, A is an integer of 1 or greater; B is an integer of 0 or greater; and C is an integer of 1 to 10. X represents a direct bond or an oxygen atom, which is arbitrarily assignable in repetitions. At least one of Y₁s represents a proton-conducting site, and the rest of Y₁s each represent a hydrogen atom or a proton-conducting site, which is arbitrarily assignable in repetitions. The proton-conducting site is made up of —SO₃H, —COOH, —PO₃H₂ or —SO₂NHSO₂R(R is an alkyl chain or a perfluoroalkyl chain).

A second aspect of the invention relates a polyparaphenylene hydrocarbon-based electrolyte having a structure represented by a formula (2):

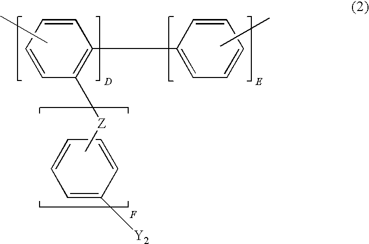

In the formula, D is an integer of 1 or greater; E is an integer of 0 or greater; and F is an integer of 1 to 10. Z represents a direct bond or an oxygen atom, which is arbitrarily assignable in repetitions. Y₂ represents a proton-conducting site made up of —SO₃H, —COOH, —PO₃H₂ or —SO₂NHSO₂R(R is an alkyl chain or a perfluoroalkyl chain).

A third aspect of the invention relates to a polyparaphenylene hydrocarbon electrolyte obtained by: performing coupling-polymerization of at least one species of monomer D represented by a formula (8), at least one species of monomer E represented by a formula (9), and at least one species of monomer F represented by a formula (10) through a use of a catalyst containing a transition metal; and converting a proton-conducting site precursor (Y₃) contained in a polymer obtained through the coupling polymerization into a proton-conducting site (Y₂).

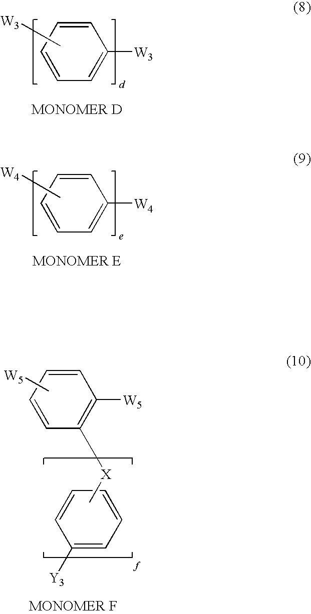

In the formula, d, e and f each are an integer of 1 to 10. X represents a direct bond or an oxygen atom, which is arbitrarily assignable in repetitions. Y₃ represents —SO₃R₁, —COOR₁, —PO(OR₁)₂ or —SO₂NHSO₂R₂. R₁ represents an alkali metal, an alkaline earth metal, quaternary ammonium or an alkyl group, and the alkyl group portion may include a heteroatom. R₂ represents an alkyl chain or a perfluoroalkyl chain. W₃ represents a halogen. W₄ represents a boronic acid or a boronic acid cyclic ester. W₅ is the same as W₃ or W₄.

A fourth aspect of the invention relates to a polyparaphenylene having a structure represented by a formula (3):

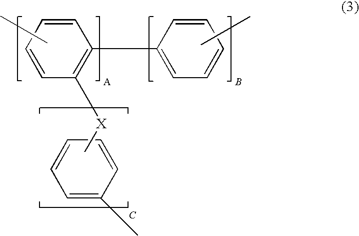

In the formula, A is an integer of 1 or greater; B is an integer of 0 or greater; and C is an integer of 1 to 10. X represents a direct bond or an oxygen atom, which is arbitrarily assignable in repetitions.

A fifth aspect of the invention relates to a polyparaphenylene having a structure represented by a formula (4):

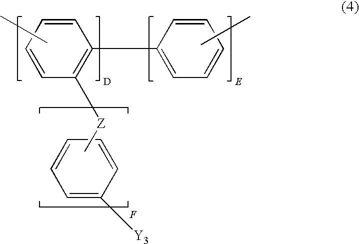

In the formula, D is an integer of 1 or greater; E is an integer of 0 or greater; and F is an integer of 1 to 10. Z represents a direct bond or an oxygen atom, which is arbitrarily assignable in repetitions. Y₃ represents —SO₃R₁, —COOR₁, —PO(OR₁)₂ or —SO₂NHSO₂R₂. R₁ represents an alkali metal, an alkaline earth metal, quaternary ammonium or an alkyl group, and the alkyl group portion may include a heteroatom. R₂ represents an alkyl chain or a perfluoroalkyl chain.

A sixth aspect of the invention relates to a manufacture method for a polyparaphenylene hydrocarbon electrolyte. This manufacture method includes: a polymerization step of performing a coupling polymerization of a monomer A shown by a formula (5) alone, or the monomer A and a monomer C shown by a formula (6) existing together, through a use of a catalyst containing a transition metal; and a proton-conducting site introduction step of introducing a proton-conducting site into any one or more of aromatic rings contained in a polymer obtained in the polymerization step and thereby obtaining a first polyparaphenylene hydrocarbon electrolyte in accordance with the invention. In this case, it is preferable that in the polymerization step, the coupling polymerization be performed through a use of a deoxygenated solvent.

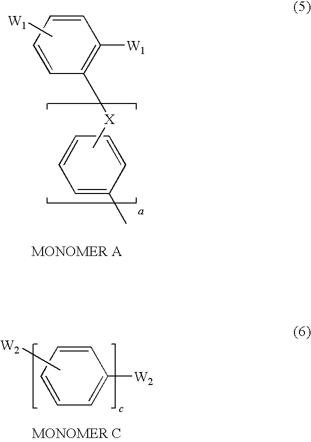

In the formula, a and c each are an integer of 1 to 10. X represents a direct bond or an oxygen atom, which is arbitrarily assignable in repetitions. W₁ and W₂ each represent a halogen, a triflate (—OTf), a Grignard (MgBr), a boronic acid or a boronic acid cyclic ester.

A seventh aspect of the invention relates to a manufacture method for a polyparaphenylene hydrocarbon electrolyte. This manufacture method includes: a polymerization step of performing a coupling polymerization of a monomer B shown by a formula (7) alone, or the monomer B and a monomer C shown by a formula (6) existing together, through a use of a catalyst containing a transition metal; and a proton-conducting site conversion step of converting a proton-conducting site precursor (Y₃) contained in a polymer obtained in the polymerization step into a proton-conducting site (Y₂) and thereby obtaining a second polyparaphenylene hydrocarbon electrolyte in accordance with the invention. In this case, it is preferable that in the polymerization step, the coupling polymerization be performed through a use of a deoxygenated solvent.

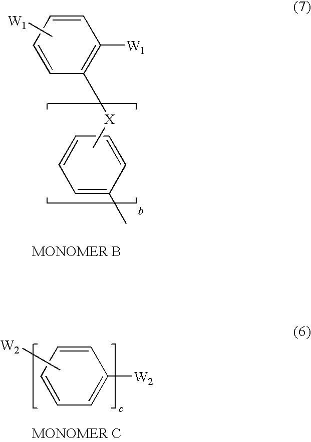

In the formula, b and c each are an integer of 1 to 10. X represents a direct bond or an oxygen atom, which is arbitrarily assignable in repetitions. Y₃ represents —SO₃R₁, —COOR₁, —PO(OR₁)₂ or —SO₂NHSO₂R₂. R₁ represents an alkali metal, an alkaline earth metal, quaternary ammonium or an alkyl group, and the alkyl group portion may include a heteroatom. R₂ represents an alkyl chain or a perfluoroalkyl chain. W₁ and W₂ each represent a halogen, a triflate (—Otf), -Grignard (—MgBr), a boronic acid or a boronic acid cyclic ester.

An eighth aspect of the invention relates to a manufacture method for a polyparaphenylene hydrocarbon electrolyte. This manufacture method includes: a polymerization step of performing a coupling polymerization of at least one species of monomer D represented by a formula (8), at least one species of monomer E represented by a formula (9), and at least one species of monomer F represented by a formula (10), through a use of a catalyst containing a transition metal; and a proton-conducting site conversion step of converting a proton-conducting site precursor (Y₃) contained in a polymer obtained in the polymerization step into a proton-conducting site (Y₂). In this case, it is preferable that in the polymerization step, the coupling polymerization be performed through a use of a deoxygenated solvent.

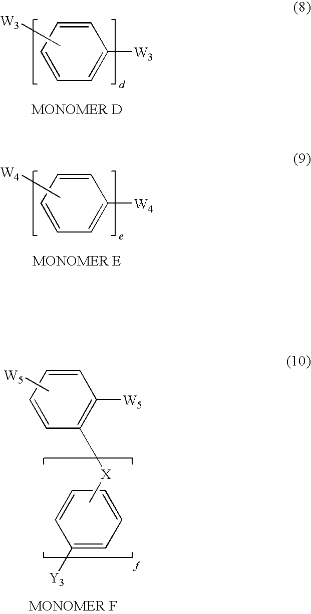

In the formula, d, e and f each are an integer of 1 to 10. S represents a direct bond or an oxygen atom, which is arbitrarily assignable in repetitions. Y₃ represents —SO₃R₁, —COOR₁, —PO(OR₁)₂ or —SO₂NHSO₂R₂. R₁ represents an alkali metal, an alkaline earth metal, quaternary ammonium or an alkyl group, and the alkyl group portion may include a heteroatom. R₂ represents an alkyl chain or a perfluoroalkyl chain. W₃ represents a halogen. W₄ represents a boronic acid or a boronic acid cyclic ester. W₅ is the same as W₃ or W₄.

Further aspects of the invention relate to an electrolyte membrane, a catalyst layer, and a solid polymer fuel cell. The electrolyte membrane, the catalyst layer and the solid polymer fuel cell each include the foregoing polyparaphenylene hydrocarbon electrolyte.

The polyparaphenylene hydrocarbon electrolyte whose main chain is made up of directly bonded aromatic rings and whose side chains are made up of aromatic rings linked via direct bonds or —O— bonds is higher in chemical durability than hydrocarbon electrolytes in which aromatic rings are linked via other bonds such as —SO₂— bonds, —CO-bonds, etc. Furthermore, the polyparaphenylene hydrocarbon electrolyte, when formed as a membrane, swells less in the planar direction of the membrane. In particular, if the proportion of the para bonds, in the main chain exceeds a certain value, the swelling in the planar direction becomes remarkably small. A reason for this is considered to be that a π-π stacking interaction acts between polymer molecules, so that rigid polymer chains align in a planar direction in the membrane. Furthermore, in the synthesis of such a polyparaphenylene hydrocarbon electrolyte, if a specific monomer is used as a starting material, a polymer with a high molecular weight can be obtained relatively easily.

Furthermore, in the synthesis of the polyparaphenylene hydrocarbon electrolyte or the polyparaphenylene in accordance with the invention, if a deoxygenated solvent considerably is used, the molecular weight of the synthesized product will be considerably increased. A reason for this is considered to be that a subsidiary reaction caused by the coordination of oxygen dissolved in the solution to the catalyst (oxidation of the catalyst) is reduced.

Furthermore, in the synthesis of the polyparaphenylene hydrocarbon electrolyte, if three or more species of monomers that satisfy specific conditions are used, the swelling resistance improves. A reason for this is considered to be that due to the use of three or more species of monomers that satisfy specific conditions, specific reactions preferentially progress, so that electrolytes form hydrophilic/hydrophobic block copolymers in a single step.

### BRIEF DESCRIPTION OF THE DRAWINGS

The foregoing and further objects, features and advantages of the invention will become apparent from the following description of exemplary embodiments with reference to the accompanying drawings, wherein like numerals are used to represent like elements and wherein:

FIG. 1 is a diagram showing the retention rates and the aromatic ring retention rates of various model compounds after the Fenton test; and

FIG. 2 is a diagram showing the electric conductivity of an electrolyte membrane obtained in Example 12.

### DETAILED DESCRIPTION OF PREFERRED EMBODIMENTS

Hereinafter, embodiments of the invention will be described in detail.

A polyparaphenylene hydrocarbon electrolyte in accordance with a first embodiment of the invention has a structure represented by the formula (1):

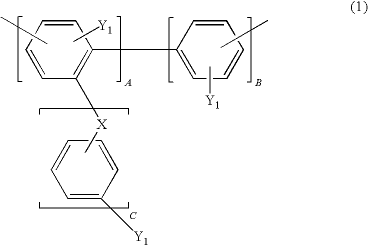

In the formula, A is an integer of 1 or greater; B is a constant of 0 or greater; and C is an integer of 1 to 10. X represents a direct bond or an oxygen atom, which is arbitrarily assignable in repetitions. From the viewpoint of heat resistance, it is preferable that X be a direct bond. At least one of Y₁s represents a proton-conducting site, and the rest of Y₁s each represent a hydrogen atom or a proton-conducting site, which is arbitrarily assignable in repetitions. Each proton-conducting site is made up of —SO₃H, —COOH, —PO₃H₂ or —SO₂NHSO₂R(R is an alkyl chain or a perfluoroalkyl chain). Particularly, each proton-conducting site is preferably —SO₃H.

In the invention, “arbitrarily assignable in repetitions” means that if the number of repeating units is 2 or greater, the Xs or Y₁s in the repeating units may be the same or different. Furthermore, in the invention, the polyparaphenylene refers to a polymer in which at least one of the inter-phenyl group bonds in the main chain is a para bond.

In the formula (1), A and B can be arbitrarily selected. Generally, if A and B are larger, an electrolyte whose solubility in water is correspondingly less and whose mechanical strength is correspondingly higher can be obtained. It is preferable that C be 10 or less. If C exceeds 10, the synthesis of the monomer becomes complicated, which is not preferable.

The bonds between the individual units (repeating units) may be any of the ortho bond, the meta bond and the para bond, which may coexist in a mixed manner. Particularly, the higher the proportion of the para bond in the main chain, the swelling of a membrane made of the polyparaphenylene in the planar direction of the membrane can be further restrained. Furthermore, if the main chain partially include ortho bonds or meta bonds, the rigid polymer can be provided with flexibility. Concretely, the proportion of the para bonds in the main chain is preferably 76 to 100 mol %, and more preferably 90 to 100 mol %.

Generally, the higher the molecular weight of the polymer, an electrolyte with higher strength can be obtained. Concretely, the number average molecular weight of the polymer is preferably 5 thousands to 5 millions, and more preferably is 100 thousands to 5 million.

If the proportion of the proton-conducting sites to the total Y₁s (particularly, sulfonic acid groups) becomes higher, the ion exchange capacity becomes greater. Concretely, the ion exchange capacity is preferably 0.1 to 4.5 meq/g, and more preferably 0.1 to 2.6 meq/g.

Next, a polyparaphenylene hydrocarbon electrolyte in accordance with a second embodiment of the invention will be described. The polyparaphenylene hydrocarbon electrolyte in accordance with this embodiment includes a substance that has a structure represented by the formula (2):

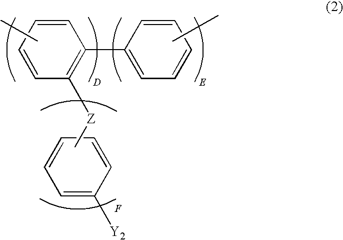

In the formula, D is an integer of 1 or greater; E is an integer of 0 or greater; and F is an integer of 1 to 10. Z represents a direct bond or an oxygen atom, which is arbitrarily assignable in repetitions. From the viewpoint of heat resistance, it is preferable that Z be a direct bond. Y₂ represents a proton-conducting site made up of —SO₃H, —COOH, —PO₃H₂ and —SO₂NHSO₂R(R is an alkyl chain or a perfluoroalkyl chain). Particularly, each proton-conducting site is preferably —SO₃H.

In the formula (2), D and E can be arbitrarily selected. Generally, if D and E are larger, an electrolyte whose solubility in water is correspondingly less and whose mechanical strength is correspondingly higher can be obtained. It is preferable that F be 10 or less. If F exceeds 10, the synthesis of the monomer becomes complicated, which is not preferable.

The bonds between the individual units may be any of the ortho bond, the meta bond and the para bond, which may coexist in a mixed manner. Particularly, the higher the proportion of the para bond in the main chain, the swelling of a membrane made of the polyparaphenylene in the planar direction of the membrane is further restrained.

The proportion of the para bonds in the main chain and the molecular weight and the ion exchange capacity of the polymer are substantially the same as in the polyparaphenylene hydrocarbon electrolyte in accordance with the first embodiment, and the description thereof will be omitted.

Next, a polyparaphenylene hydrocarbon electrolyte in accordance with a third embodiment of the invention will be described. The polyparaphenylene hydrocarbon electrolyte in accordance with this embodiment is obtained by: performing coupling-polymerization of at least one species of monomer D represented by a formula (8), at least one species of monomer E represented by a formula (9), and at least one species of monomer F represented by a formula (10) through a use of a catalyst containing a transition metal; and converting a proton-conducting site precursor (Y₃) contained in a polymer obtained through the coupling polymerization into a proton-conducting site (Y₂).

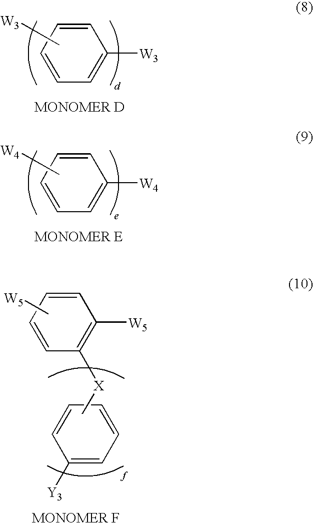

In the formula, d, e and f each are an integer of 1 to 10. X represents a direct bond or an oxygen atom, which is arbitrarily assignable in repetitions. Y₃ represents —SO₃R₁, —COOR₁, —PO(OR₁)₂ or —SO₂NHSO₂R₂. R₁ represents an alkali metal, an alkaline earth metal, quaternary ammonium or an alkyl group, and the alkyl group portion may include a heteroatom (e.g., oxygen). R₂ represents an alkyl chain or a perfluoroalkyl chain. W₃ represents a halogen. W₄ represents a boronic acid or a boronic acid cyclic ester. W₅ is the same as W₃ or W₄.

As for the polyparaphenylene hydrocarbon electrolyte in accordance with the third embodiment, the proportion of the para bonds in the main chain and the molecular weight and the ion exchange capacity of the polymer are substantially the same as in the polyparaphenylene hydrocarbon electrolyte in accordance with the first embodiment, and the description thereof will be omitted. Details of the monomers to be used and the synthesis condition will be described below.

Next, the polyparaphenylene in accordance with the invention will be described. The polyparaphenylene in accordance with the first embodiment of the invention has a structure represented by the formula (3):

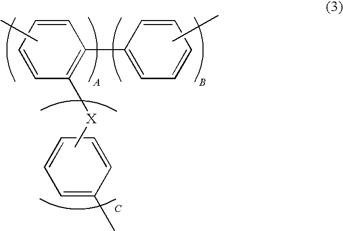

In the formula, A is an integer of 1 or greater; B is an integer of 1 or greater; and C is an integer of 1 to 10. X represents a direct bond or an oxygen atom, which is arbitrarily assignable in repetitions. From the viewpoint of heat resistance, it is preferable that X be a direct bond.

The polyparaphenylene represented by the formula (3) is an intermediate product obtained in a process of synthesizing a polyparaphenylene hydrocarbon electrolyte represented by the formula (1). Details of A, B, C and X in the formula (3), the proportion of the para bonds in the main chain and the molecular weight of the polymer are substantially the same as in the polyparaphenylene hydrocarbon electrolyte represented by the formula (1), and the description thereof will be omitted.

Next, the polyparaphenylene in accordance with the second embodiment of the invention will be described. The polyparaphenylene in accordance with the second embodiment has a structure represented by the formula (4).

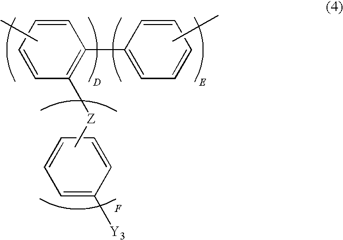

In the formula, D is an integer of 1 or greater; E is an integer of 0 or greater; and F is an integer of 1 to 10. Z represents a direct bond or an oxygen atom, which is arbitrarily assignable in repetitions. From the viewpoint of heat resistance, it is preferable that Z be a direct bond. Y₃ represents —SO₃R₁, —COOR₁, —PO(OR₁)₂ or —SO₂NHSO₂R₂. R₁ represents an alkali metal, an alkaline earth metal, quaternary ammonium or an alkyl group, and the alkyl group portion may include a heteroatom (e.g., oxygen). R₂ represents an alkyl chain or a perfluoroalkyl chain.

The polyparaphenylene represented by the formula (4) is an intermediate product obtained in a process of synthesizing the polyparaphenylene hydrocarbon electrolyte represented by the formula (2). Details of D, E, F and Z in the formula (4), the proportion of the para bonds in the main chain, the polymer molecular weight, and the amount of the proton-conducting site precursor (Y₃) (i.e., ion exchange capacity) are substantially the same as in the polyparaphenylene hydrocarbon electrolyte represented by the formula (2), and the description thereof will be omitted.

Next, the manufacture method for the polyparaphenylene hydrocarbon electrolyte in accordance with the invention will be described. A manufacture method for a polyparaphenylene hydrocarbon electrolyte in accordance with the first embodiment of the invention is a method of manufacturing the polyparaphenylene hydrocarbon electrolyte represented by the formula (1), and includes a polymerization step, and a proton-conducting site introduction step.

The polymerization step is a step of performing a coupling polymerization of a monomer A shown by the formula, (5) alone, or the monomer A and a monomer C shown by the formula (6) existing together, through the use of a catalyst containing a transition metal. Therefore, a polyparaphenylene represented by the formula (3) can be obtained.

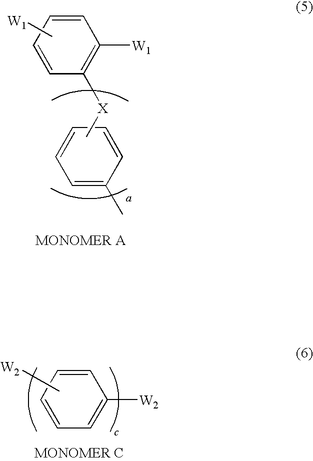

In the formula, a and c each are an integer of 1 to 10. If a or c exceeds 10, the synthesis of the monomer becomes complicated, which is not preferable. X represents a direct bond or an oxygen atom, which is arbitrarily assignable in repetitions. W₁ and W₂ each represents a halogen (e.g., chlorine, bromine, iodine, etc.), a triflate (—OTf), a Grignard (—MgBr), a boronic acid or a boronic acid cyclic ester.

Concrete examples of the boronic acid cyclic ester include a cyclic ester of ethylene glycol and boronic acid; a cyclic ester of propylene glycol and boronic acid, a cyclic ester of neopentyl glycol and boronic acid. If in the monomer A, W₁ is boronic acid or boronic acid cyclic ester, it is preferable that W₂ in the monomer C be a halogen, and crosscoupling be accomplished.

The monomer A and the monomer C are commercially available, or can be synthesized by using, as a starting material, a commercially available monomer having a similar molecular structure, and performing a well-known process (e.g., polycondensation, functional group conversion, etc.) on the starting material.

For example, a monomer A in which W₁ is bromine, X is a direct bond, and a is 1 (e.g., 2,5-dibromobiphenyl) can be obtained by using 2,5-dibromoaniline as a starting material, and converting it into 2,5-dibromophenyl diazonium chloride, and reacting this with benzene in the presence of sodium acetate.

For example, a monomer A in which W₁ is bromine, X is a direct bond, and a is 2 or greater can be synthesized by using biphenyl, terphenyl or the like instead of benzene in the foregoing synthesis method.

For example, a monomer A in which W₁ is bromine, X is a —O— bond, and a is 1 to 10 can be synthesized by reacting 1,4-dibromo-2-iodobenzene with phenol or the like under a basic condition.

Furthermore, for example, a monomer C in which c is 3 or greater can be synthesized by reacting a monomer C in which c=1 or 2 with a benzene, a biphenyl or the like that has one bromo and one boronic acid.

If W₁ is a a triflate, such a monomer A can be obtained by performing synthesis through the use of 2,5-dihydroxyaniline instead of 2,5-dibromoaniline according to the foregoing synthesis method, and then reacting the synthesized product with trifluoromethane sulfonic anhydride (TfO₂) in a solvent such as pyridine or the like.

If W₁ is Grignard, such a monomer A can be obtained by synthesizing a monomer in which W₁ is bromine according to the foregoing synthesis method, and then reacting the synthesized monomer with Mg in a solvent such as ether, THF, etc.

If W₁ is boronic acid, such a monomer A can be obtained by synthesizing a monomer in which W₁ is bromine according to the foregoing synthesis method, and then reacting the synthesized monomer with isopropylmagnesium bromide (i-PrMgBr) in a solvent such as ether or the like, and then reacting the product with trimethoxyborane (B(OMe)₃) in a solvent such as ether or the like, and then hydrolyzing the product with hydrochloric acid or the like.

If W₁ is boronic acid cyclic ester, such a monomer A can be obtained by synthesizing a monomer in which W₁ is boronic acid, and then reacting the synthesized monomer with a diol compound (HO—R—OH).

The ratio between the monomer A and the monomer C can be arbitrarily selected if W₁ and W₂ each are a halogen, a triflate or a Grignard. If W₁ is boronic acid or boronic acid cyclic ester and W₂ is a halogen and W₃ is boronic acid or boronic acid cyclic ester, the ratio between the monomer A and the monomer C is preferably 1:1 in molar ratio.

Generally, if the proportion of the monomer A in the raw material is higher, a polymer of which the number of side chains per molecule is large (B in the equation (1) is small) can be obtained.

The monomer A and the monomer C blended at a predetermined ratio are caused to undergo coupling polymerization through the use of a catalyst containing a transition metal under a nitrogen atmosphere. The catalyst used in the coupling polymerization may be a metal compound that contains Ni, Pd, Cu, etc. Particularly, it is preferable that the catalyst be a transition metal complex. Furthermore, the catalyst may contain one species of transition metal, or may also contain two or more species of transition metals. The kind of the catalyst for use is an optimal catalyst that is selected in accordance with the kinds of the monomers.

For example, in the case where a monomer A in which W₁ is bromine is caused to undergo coupling polymerization, or in the case where a monomer A in which W₁ is bromine and a monomer C in which W₂ is bromine are caused to undergo coupling polymerization, the catalyst for use may be NiCl₂(PPh)₃, Ni(cod)₂, etc. In this case, it is preferable to use a metal, such as zinc or the like, as a reducing agent.

Furthermore, if a monomer A in which W₁ is bromine or a monomer C in which W₂ is boronic acid or boronic acid cyclic ester is caused to undergo coupling polymerization, it is preferable to use Pd(PPh₃)₄ for the catalyst for use.

As for the solvent, it is preferable to use a mixture solvent of water and a polar solvent such as dimethyl sulfoxide (DMSO), tetrahydrofuran (THF), etc. The reaction temperature is preferably a temperature that does not inhibit the catalyst reaction. Furthermore, in order to accelerate the polymerization rate, it is permissible to add a ligand, such as triphenylphosphine(PPh₃), 2,2′-bipyridyl, etc., or a salt such as Et₄NI, NaI, etc.

Furthermore, if the polymerization condition is optimized, the molecular weight of the polymer can be arbitrarily controlled. Concrete examples of the method of making the molecular weight relatively large include a method in which a long-chain alkyl group is introduced into side chains, a method in which the polymerization catalyst is optimized, a method in which the polymerization is performed at high temperature, etc. After the polymerization, the reaction substance was purified by reprecipitation from a poor solvent such as methanol or the like, so as to obtain the polymer.

As for the coupling polymerization, it is preferable to use a deoxygenated solvent in particular. The coupling polymerization through the use of a deoxygenated solvent facilitates the synthesis of a polyparaphenylene having a high molecular weight of 100 thousands or greater. This is considered to be because the dissolved oxygen that inhibits the polymer reaction can be eliminated from the reaction system.

Examples of the method of eliminating the dissolved oxygen from a solvent include:

(1) a method in which a pre-deoxygenation solvent is bubbled with an inert gas (e.g., N₂, Ar, etc.),
(2) a method in which an operation of freezing a pre-deoxygenation solvent in a container, and reducing pressure in the container, and then melting the solvent is repeated a plurality of times;
(3) a combination of these methods, etc.
Generally, the dissolved oxygen can be further reduced if the time of bubbling is lengthened and/or if the number of repetition times of the operation of freezing, reducing pressure and melting is increased.

The proton-conducting site introduction step is a step of introducing a proton-conducting site into one or more of aromatic rings contained in the polymer obtained in the polymerization step and thereby obtaining a polyparaphenylene hydrocarbon electrolyte shown by the formula (1). As for the method of introducing a proton-conducting site into one or more aromatic rings, an optimal method is selected in accordance with the kind of the proton-conducting site.

For example, if the proton-conducting site is sulfonic acid group (—SO₃H), the introduction of the sulfonic acid group is performed by, for example, dropping chlorosulfonic acid in a solvent, such as 1,2-dichloroethane or the like, which contains the polymer, and then pouring water into the reaction mixture. This introduces the sulfonic acid group into one or more aromatic groups contained in the repetition units A, B, C. Besides, if the condition of introduction of the sulfonic acid group is optimized, the ion exchange capacity can be arbitrarily controlled. Generally, if the amount of chlorosulfonic acid added is made greater, an electrolyte whose ion exchange capacity is correspondingly higher is obtained. In order to introduce the sulfonic acid group, other reagents, such as sulfuric acid or the like, may also be used.

Furthermore, if the proton-conducting site is a carboxylic acid group (—COOH), the carboxylic acid group can be introduced by, for example, reacting the polymer with 2-chloropropane in the presence of AlCl₃ in an organic solvent, and then causing oxidation in a potassium permanganate aqueous solution. The greater the amount of 2-chloropropane used, the greater the amount of the carboxylic acid group introduced becomes, so that an electrolyte whose ion exchange capacity is correspondingly higher is obtained.

Furthermore, if the proton-conducting site is a phosphonic acid group (—PO₃H₂), the phosphonic acid group can be introduced by, for example, reacting the polymer with bromine in the presence of FeBr₃ so as to introduce bromine atoms into aromatic rings, and then reacting the polymer with diethyl hypophosphite (HPO(Oet)₂) in the presence of tetrakis(triphenylphosphine)palladium in a solvent of triethyl amine, and then hydrolyzing the phosphonic acid ester with hydrochloric acid. The greater the amount of bromine used, the greater the amount of the phosphonic acid group introduced becomes, so that an electrolyte whose ion exchange capacity is correspondingly high is obtained.

Furthermore, for example, if the proton-conducting site is a bis-sulfonimide group (—SO₂NHSO₂R), the bis-sulfonimide group can be introduced by, for example, introducing the sulfonic acid group into the polymer as in the foregoing method, and then converting the sulfonic acid group into sodium sulfonate through the use of NaOH, and then reacting it with POCl₃ to obtain sulfonic acid chloride, and then reacting it with alkyl sulfonamide or perfluoroalkyl sulfonamide. The greater the initial amount of the sulfonic acid group used, the greater the amount of the bis-sulfonimide group introduced becomes, so that an electrolyte whose ion exchange capacity is correspondingly high is obtained.

Next, a manufacture method for the polyparaphenylene hydrocarbon electrolyte in accordance with the second embodiment of the invention will be described. The manufacture method for the polyparaphenylene hydrocarbon electrolyte in accordance with this embodiment is a method of manufacturing a polyparaphenylene hydrocarbon electrolyte shown by the formula (2), and includes a polymerization step, and a proton-conducting site conversion step.

The polymerization step is a step of performing a coupling polymerization of a monomer B shown by the formula (7) alone, or the monomer B and a monomer C shown by the formula (6) existing together, through the use of a catalyst containing transition metal. This provides a polyparaphenylene shown by the formula (4).

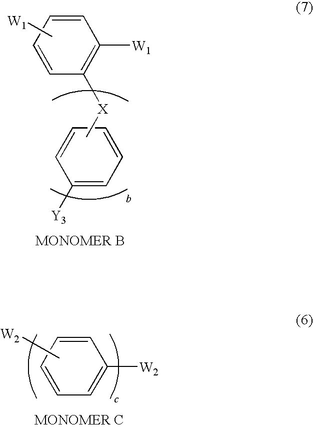

In the formula, b and c each are an integer of 1 to 10. X represents a direct bond or an oxygen atom, which is arbitrarily assignable in repetitions. Y₃ represents a proton-conducting site precursor selected from —SO₃R₁, —COOR₁, —PO(OR₁)₂ and —SO₂NHSO₂R₂. R₁ represents an alkali metal (e.g., Na or the like), an alkaline earth metal (e.g., Ca or the like), quaternary ammonium or an alkyl group, and the alkyl group portion may include a heteroatom (e.g., oxygen). R₂ represents an alkyl chain or a perfluoroalkyl chain. W₁ and W₂ represents a halogen (e.g., chlorine, bromine, iodine, etc.), a triflate (—OTf), a Grignard (—MgBr), a boronic acid or a boronic acid cyclic ester.

Concrete examples of the boronic acid cyclic ester include a cyclic ester of ethylene glycol and boronic acid, a cyclic ester of propylene glycol and boronic acid, a cyclic ester of neopentyl glycol and boronic acid. If in the monomer B, W₁ is boronic acid or boronic acid cyclic ester, it is preferable that W₂ in the monomer C be a halogen, and crosscoupling be accomplished.

The monomer B is commercially available, or can be synthesized by using, as a starting material, a commercially available monomer having a similar molecular structure, and performing a well-known process (e.g., polycondensation, functional group conversion, etc.) on the starting material.

### 1. Synthesis Example 1

### —SO₃R₁-Containing Monomer

For example, a monomer B in which W₁ is bromine, X is a direct bond, b is 1, Y₃ is —SO₃R₁, and R₁ is Na (e.g., sodium 2,5-dibromobiphenyl-4′-sulfonate) is obtained by using 2,5-dibromobiphenyl as a starting material, and reacting this with chlorosulfonic acid, and then reacting the reaction product with NaOH.

Furthermore, for example, a monomer B in which W₁ is bromine, X is a direct bond, b is 1, Y₃ is —SO₃R₁, and R₁ is an alkyl group (e.g., an ester of 2,5-dibromobiphenyl-4′-sulfonic acid chloride and an alcohol (e.g., 1,3-diethoxy-2-propanol)) is obtained by reacting 2,5-dibromobiphenyl-4′-sulfonic acid chloride and an alcohol (e.g., 1,3-diethoxy-diethoxy-2-propanol).

Furthermore, for example, a monomer B in which W₁ is bromine, X is a direct bond b is 1, Y₃ is —SO₃R₁, and R₁ is quaternary ammonium (e.g., benzyltrimethylammonium 2,5-dibromobiphenyl-4′-sulfonate) is obtained by reacting 2,5-dibromobiphenyl-4′-sulfonic acid chloride and a quaternary ammonium halide (e.g., benzyltrimethylammonium chloride) in water.

Furthermore, for example, a monomer B in which X is a —O— bond, and b is 1 or greater can be synthesized by introducing a —SO₃R₁ group into a monomer A in which X is a —O— bond through the use of a well-known method.

### 2. Synthesis Example 2

### —COOR₁-Containing Monomer

Monomers B in which Y₃ is —COOR₁ can be synthesized by methods as follows.

For example, a monomer B in which W₁ is bromine, X is a direct bond, b is 1, and R₁ is Na (e.g., sodium(4-(2,5-dibromophenyl)benzoate salt) is obtained by using 2,5-dibromoaniline as a starting material, and converting it into 2,5-dibromophenyldiazonium chloride, and reacting this with toluene in the presence of sodium acetate, and oxidizing this with a potassium permanganate aqueous solution, and then reacting this with a NaOH aqueous solution.

For example, a monomer B in which W₁ is bromine, X is a direct bond, b is 1, and R₁ is an alkyl(butyl) (e.g., butyl (4-(2,5-dibromophenyl)benzoate) is obtained by using 2,5-dibromoaniline as a starting material, and converting it into 2,5-dibromophenyl diazonium chloride, and reacting this with toluene in the presence of sodium acetate, and oxidizing this with a potassium permanganate aqueous solution, and introducing thereinto carboxylic acid group, and converting it into carboxylic acid chloride through the use of thionyl chloride, and then reacting this with butanol.

Furthermore, for example, a monomer B in which W₁ is bromine, X is a direct bond, b is 1, and R₁ is a quaternary ammonium (e.g., benzyltrimethylammonium (4-(2,5-dibromophenyl)benzoate)) is obtained by using 2,5-dibromoaniline as a starting material, and converting it into 2,5-dibromophenyldiazonium chloride, and reacting this with toluene in the presence of sodium acetate, and oxidizing this with a potassium permanganate aqueous solution, and introducing thereinto carboxylic acid group, and then reacting this with a quaternary ammonium halide (benzyltrimethylammonium chloride) in water.

For example, a monomer B in which W₁ is bromine, X is a direct bond, and b is 2 or greater can be synthesized by using 4-methylbiphenyl, 4-methylterphenyl, etc., instead of toluene in the foregoing synthesis method.

For example, a monomer B in which W₁ is bromine, X is a —O— bond, b is 1, and R₁ is Na is obtained by reacting 2,5-dibromo-iodobenzene and p-cresol under a basic condition, and oxidizing this in a potassium permanganate aqueous solution, and then reacting this with a NaOH aqueous solution.

For example, a monomer B in which W₁ is bromine, X is a —O— bond, b is 1, and R₁ is an alkyl(butyl) is obtained by reacting 2,5-dibromo-iodobenzene and p-cresol under a basic condition, and oxidizing this in a potassium permanganate aqueous solution, and introducing thereinto carboxylic acid group, and converting this into carboxylic acid chloride through the use of thionyl chloride, and then reacting this with butanol.

For example, a monomer B in which W₁ is bromine, X is a —O— bond, and b is or greater can be synthesized by using p-(4-tolyloxy)-phenol, p-(4-(4-tolyloxy)-phenoxy)-phenol, etc. instead of p-cresol in the foregoing synthesis method.

### 3. Synthesis Example 3

### —PO(OR₁)₂-Containing Monomer

Monomers B in which Y₃ is —PO(OR₁)₂ can be synthesized by methods as follows.

For example, a monomer B in which W₁ is bromine, X is a direct bond, b is 1, and R₁ is Na (e.g., sodium (4-(2,5-dibromophenyl)benzenephosphonate salt) is obtained by using 2,5-dibromoaniline as a starting material, and converting this into 2,5-dibromophenyldiazonium chloride, and then reacting this with sodium benzenephosphonate salt in the presence of sodium acetate.

For example, a monomer B in which W₁ is bromine, X is a direct bond, b is 1, and R₁ is an alkyl (e.g. ethyl) (e.g., diethyl (4-(2,5-dibromophenyl)benzenephosphonate)) is obtained by using diethyl benzenephosphonate instead of sodium benzenesulfonate salt in the foregoing synthesis method.

For example, a monomer B in which W₁ is bromine, X is a direct bond, b is 1, R₁ is quaternary ammonium (e.g., benzyltrimethylammonium (4-(2,5-dibromophenyl)benzenephosphonate)) is obtained by synthesizing sodium 4-(2,5-dibromophenyl)benzenesulfonate salt in the foregoing synthesis method, and then converting it into a phosphonic acid through the use of an acidic aqueous solution (e.g., HCl aqueous solution), and reacting this with a quaternary ammonium halide (benzenetrimethylammonium chloride) in water.

For example, a monomer B in which W₁ is bromine, X is a —O— bond, b is 1, and R₁ is Na can be synthesized by reacting 2,5-dibromo-iodobenzene and sodium 4-hydroxybenzenephosphonate salt under a basic condition.

For example, a monomer B in which W₁ is bromine, X is a —O— bond b is 1, and R₁ is an alkyl(ethyl) is obtained by using diethyl 4-hydroxybenzenephosphonate instead of sodium 4-hydroxybenzenephosphonate salt in the foregoing synthesis method.

For example, a monomer B in which W₁ is bromine, X is a —O— bond, b is 2 or greater, and R₁ is Na can be synthesized by using sodium p-(4-hydroxyphenoxy)benzenephosphonate salt instead of sodium 4-hydroxybenzenephosphonate salt in the foregoing synthesis method.

### 4. Synthesis Example 4

### —SO₂NHSO₂R₂-Containing Monomer

In a —SO₃R₁-containing monomer in which R₁ is Na, the bis-sulfonimide group can be introduced by reacting the monomer with POCl₃ to obtain sulfonic acid chloride, and then reacting this with alkyl sulfonamide or perfluoroalkyl sulfonamide. Examples of the alkyl include methyl, ethyl, propyl, butyl, isobutyl, etc. Examples of the perfluoroalkyl include perfluoromethyl, perfluoroethyl, perfluoropropyl, perfluorobutyl, perfluoroisobutyl, etc.

### 5. Synthesis Example 5

### Monomer in which W₁ is a Triflate, a Grignard, a Boronic Acid or a Boronic Acid Cyclic Ester

If W₁ is a triflate, the monomer is obtained by performing synthesis as in the foregoing synthesis method through the use of 2,5-dihydroxyaniline instead of 2,5-dibromoaniline, and then reacting this with trifluoromethane sulfonic anhydride (TfO₂) in a solvent such as pyridine or the like. However, if there is a possibility of the OH group reacting during various synthesis processes, it is necessary to protect the OH group with an appropriate protection group (e.g., tosyl group, or the like) and then perform a reaction of removing the protection.

If W₁ is a Grignard, the monomer is obtained by synthesizing a monomer in which W₁ is bromine in the foregoing synthesis method, and then reacting this with Mg in a solvent such as ether, THF, etc.

If W₁ is boronic acid, the monomer is obtained by synthesizing a monomer in which W₁ is bromine in the foregoing synthesis method, and reacting this with isopropylmagnesium bromide (i-PrMgBr) in a solvent, such as ether or the like, and then reacting this with trimethoxyborane (B(OMe)₃) in a solvent, such as ether or the like, and then hydrolyzing this with hydrochloric acid or the like.

If W₁ is a boronic acid cyclic ester, the monomer is obtained by synthesizing a monomer in which W₁ is boronic acid in the foregoing synthesis method, and then reacting this with a diol compound (HO—R—OH).

The ratio between the monomer B and the monomer C can be arbitrarily selected if W₁ and W₂ each are a halogen, a triflate, or a Grignard. It is preferable that the ratio between the monomer B and the monomer C be 1:1 in molar ratio in the case where W₁ is boronic acid or a boronic acid cyclic ester and W₂ is a halogen, and in the case where W₁ is a halogen and W₂ is boronic acid or a boronic acid cyclic ester.

Generally, if the proportion of the monomer B contained in the raw material is higher, a polymer whose number of side chains per molecule is correspondingly greater (E in the formula (2) is correspondingly smaller) is obtained. Furthermore, if the proportion of the monomer B contained in the raw material is higher, an electrolyte whose ion exchange capacity is correspondingly higher is obtained.

Other respects regarding the polymerization step (i.e., respects regarding the catalyst and the solvent) are substantially the same as in the first embodiment, and the description thereof will be omitted below.

The proton-conducting site conversion step is a step of converting a proton-conducting site precursor (Y₃) contained in the polymer obtained in the polymerization step into a proton-conducting site (Y₂), and thereby obtaining a polyparaphenylene hydrocarbon electrolyte represented by the formula (2).

In the case of a polymer synthesized from a sodium sulfonate monomer, sodium sulfonate can be converted into the sulfonic acid group by dipping the polymer into an acidic aqueous solution (e.g., HCl aqueous solution or the like).

In the case of a polymer synthesized from a sulfonic acid ester monomer, the sodium sulfonate group can be converted into the sulfonic acid group by hydrolyzing the sulfonic acid ester through the reaction of the polymer with a base, such as NaOH or the like, in an appropriate solvent (e.g., n-butanol), and then dipping this into an acidic aqueous solution (e.g., HCl aqueous solution or the like).

Furthermore, —COOR₁ and —PO(OR₁)₂ contained in the polymer can be converted into —COOH and —PO(OH)₂, respectively, by dipping the polymer into an acidic aqueous solution (e.g., HCl aqueous solution or the like) if R₁ is an alkali metal or an alkaline earth metal.

Furthermore, if R₁ is an alkyl group, COOR₁ and —PO(OR₁)₂ contained in the polymer can be converted into —COOH and —PO(OH)₂, respectively, by hydrolyzing the —COOR₁ and —PO(OH₁)₂ through the reaction of the polymer with a base, such as NaOH or the like, in an appropriate solvent (e.g., n-butanol), and then dipping this into an acidic aqueous solution (e.g., HCl. aqueous solution or the like).

Furthermore, a proton-conducting site precursor (Y₃) in which R₁ is quaternary ammonium can be converted into —SO₃H, —COOH or —PO(OH)₂ by dipping the polymer into an acidic aqueous solution (e.g., HCl aqueous solution).

Incidentally, after the proton-conducting site precursor is converted into a proton-conducting site, a proton-conducting site may further be introduced into an aromatic ring via the above-described proton-conducting site introduction step.

Next, a manufacture method for a polyparaphenylene hydrocarbon electrolyte in accordance with the third embodiment of the invention will be described. The manufacture method for the polyparaphenylene hydrocarbon electrolyte in accordance with this embodiment is a manufacture method of producing a polyparaphenylene hydrocarbon electrolyte by using at least three kinds of monomers, and includes a polymerization step and a proton-conducting site conversion step.

The polymerization step is a step of performing a coupling polymerization of at least one species of monomer D represented by the formula (8), at least one species of monomer E represented by the formula (9), and at least one species of monomer F represented by the formula (10), through the use of a catalyst containing a transition metal.

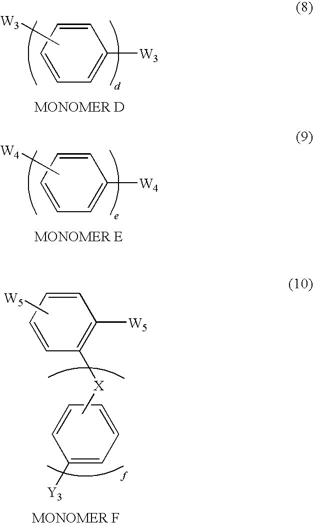

In the formula, d, e and f each are an integer of 1 to 10. If d, e or f exceeds 10, the synthesis of the monomer becomes complicated, which is not preferable. X represents a direct bond or an oxygen atom, which is arbitrarily assignable in repetitions. Y₃ represents —SO₃R₁, —COOR₁, —PO(OR₁)₂ or —SO₂NHSO₂R₂. R₁ represents an alkali metal, an alkaline earth metal, quaternary ammonium or an alkyl group, and the alkyl group portion may include a heteroatom (e.g., oxygen). R₂ represents an alkyl chain or a perfluoroalkyl chain. W₃ represents a halogen. W₄ represents a boronic acid or a boronic acid cyclic ester. W₅ is the same as W₃ or W₄.

The monomers D, E are the same as the foregoing monomer C, except that the functional groups W₃, W₄ each satisfy a specific condition, and detailed description of the construction and the manufacture method of the monomers D, E will be omitted below. Likewise, the monomer F is the same as the foregoing monomer B, except that the functional group W₅ satisfies a specific condition, and detailed description of the construction and the manufacture method of the monomer F will be omitted below.

As for the monomer D, it is permissible to use one species of monomer that satisfies the foregoing specific condition, and two or more species of such monomers. This applies to the monomers E and F as well.

It is preferable that the ratio among the monomers D, E and F be such a ratio that the molar ratio of the halogen and the boronic acid or the boronic acid cyclic ester be 1:1. For example, if W₅ and W₃ are the same, the ratio of monomer E:(monomer D+monomer F) is preferably 1:1. In this case, the ratio between the monomer D and the monomer F can be arbitrarily selected in accordance with the purpose. Generally, it the proportion of the monomer F contained in the raw material is higher, an electrolyte whose ion exchange capacity is correspondingly higher is obtained.

If W₅ and W₃ are the same, the monomer D plays the role of forming a hydrophobic portion in the polymer. The ratio of the monomer D affects the solubility of the synthesized polymer to a solvent (e.g., DMAc), a membrane formability, and a hot water resistance. Generally, if the amount of the monomer D is excessively small, the hydrophobicity of the polymer becomes insufficient, so that sufficient hot-water resistance. On the other hand, if the amount of the monomer D is excessively large, the solubility and the membrane formability becomes insufficient. Therefore, as for the ratio of the monomer that functions to form the hydrophobic portion (the monomer D in the foregoing case), it is preferable to select an optimal ratio in accordance with the characteristics that are required with respect to the polymer.

Other respects regarding the polymerization step (i.e., respects regarding the catalyst and the solvent) are the same as in the first embodiment, and the description thereof will be omitted below.

The proton-conducting site conversion step is a step of converting a proton-conducting site precursor (Y₃) contained in the polymer obtained in the polymerization step into a proton-conducting site (Y₂). Details of the proton-conducting site conversion step are the same as in the manufacture method for the polyparaphenylene hydrocarbon electrolyte in accordance with the second embodiment, and the description thereof will be omitted below.

Next, an electrolyte membrane, a catalyst layer and a solid polymer fuel cell employing the polyparaphenylene hydrocarbon electrolyte in accordance with the invention will be described.

An electrolyte membrane employing a polyparaphenylene hydrocarbon electrolyte in accordance with the invention is obtained by dissolving an electrolyte in an appropriate solvent, and casting the solution onto an appropriate substrate surface, and then removing the solvent. The electrolyte membrane may also be obtained by forming into a membrane a polymer without a proton-conducting site (e.g., sulfonic acid group) introduced, or a polymer with a proton-conducting site precursor (e.g., —SO₃R₁ group) introduced, and then introducing a proton-conducting site or converting the proton-conducting site precursor into a proton-conducting site. Furthermore, if the polyparaphenylene hydrocarbon electrolyte or the precursor thereof is hardly soluble in a solvent, it may be formed into a membrane by a melting-casting process.

Furthermore, the electrolyte membrane may be a membrane made only of the polyparaphenylene hydrocarbon electrolyte, or may also be a composite of the electrolyte membrane and a reinforcement material. Even in the case where the electrolyte membrane is made only of a polyparaphenylene hydrocarbon electrolyte, the optimization of the molecular structure of the polyparaphenylene hydrocarbon electrolyte makes it possible to obtain an electrolyte membrane whose swelling rate (=proportion of the elongation of the membrane in a water-containing state to the dry membrane dimension) in planar direction of the membrane is 10% or less, or 5% or less.

Furthermore, a catalyst layer employing a polyparaphenylene hydrocarbon electrolyte in accordance with the invention is obtained by dissolving an electrolyte in an appropriate solvent, and adding thereinto a catalyst or a catalyst-loaded support (e.g., Pt/C) to obtain a catalyst ink, and applying the ink to an appropriate substrate surface, and then removing the solvent.

Furthermore, a solid polymer fuel cell employing a polyparaphenylene hydrocarbon electrolyte in accordance with the invention is obtained by making an MEA through the use of an electrolyte membrane and/or a catalyst layer obtained as described above, and then sandwiching the MEA from both sides with separators that have gas channels.

Next described will be operation of the polyparaphenylene hydrocarbon electrolyte in accordance with the invention, the manufacture method therefor, and the polyparaphenylene, as well as the electrolyte membrane, the catalyst layer and the solid polymer fuel cell that employ the polyparaphenylene hydrocarbon electrolyte.

Among the hydrocarbon-based electrolytes, electrolytes having aromatic rings have an advantage of being relatively high in strength and allowing each introduction of proton-conducting sites. However, hydrocarbon-based electrolytes that contain —S—, —SO₂—, —CO—, etc. in their main or side chains are low in the chemical stability against hydroxyl radicals.

Polyparaphenylene hydrocarbon electrolytes whose main chain is made up of directly bonded aromatic rings and whose side chains are made up of aromatic rings directly bonded or bonded via —O— bonds are higher in chemical durability than hydrocarbon electrolytes in which aromatic rings are linked via other bonds, such as —SO₂— bonds, —CO— bonds, etc. Therefore, if this polyparaphenylene hydrocarbon electrolyte is as, for example, an electrolyte for a fuel cell, durability improvement and cost reduction of the fuel cell can be achieved.

Furthermore, as for the polyparaphenylene hydrocarbon electrolyte, the swelling of a membrane made thereof in a planar direction of the membrane is smaller than in a direction of membrane thickness. Particularly, the higher the proportion of the para bonds in the main chain, the smaller the swelling in the planar direction. It is considered that since the polyparaphenylene hydrocarbon electrolyte is a rigid polymer, the casting formation of membrane from the electrolyte causes π-π stacking interactions between polymer molecules, so that the polymer chains align in the planar direction of the membrane. Furthermore, the π-π stacking interactions between phenyl groups of different polymer molecules is considered to be higher the higher the proportion of the para bonds in the main chain.

Therefore, it is considered that the higher the proportion of the para bonds in the main chain, the electrolyte membrane more remarkably shows a swelling anisotropy in which there is substantially no swelling in the planar direction and swelling occurs in the membrane thickness direction. Furthermore, if the main chain contains an ortho bond or a meta bond, the rigid polymer can be provided with softness.

Therefore, if a specific monomer is used as a starting material for the synthesis of a polyparaphenylene hydrocarbon electrolyte as mentioned above, a high-molecular weight polymer can be relatively easily obtained. In particular, if a monomer with the sulfonic acid ester group introduced is used, the solubility in the polymerization improves, thus providing a high-molecular weight polymer. Therefore, if this polymer is used to form a membrane, an electrolyte membrane with high mechanical strength is obtained.

Generally, in order to synthesize a polymer of high molecular weight, it is important that the reaction be not allowed to end partway through the polymerization. The end of the polymerization reaction is considered to occur either in conjunction with an essential chemical phenomenon or due to deposition of growing polymer chains in an early stage of the growth. For restraining the deposition of a polymer, there are known a method in which side chains made up of long-chain alkyl groups or polar substituent groups are introduced into the polymer so that affinity to the polymerization solvent is provided (see Acta Polymer., 44, 59-69 (1993), J. Polym. Sci., Part A: Polym. Chem., 39, 1533-1544 (2001)), and a method in which the polymerization is performed at a temperature that does not inhibit the polymerization reaction, through the utilization of the characteristic that the solubility of the polymer rises with rises in the temperature (see JP-A-2005-248143). Furthermore, there has been no report in which a polyparaphenylene high-molecular compound of increased molecular weight as mentioned above was successfully provided by a method other than the methods in which the deposition of a polymer is restrained.

The inventors of this application has found that in the synthesis of a polyparaphenylene high-molecular compound, the use of a deoxygenated solvent dramatically enhances the molecular weight of the synthesized compound. The synthesis of a polyparaphenylene high-molecular compound often employs a transition metal complex, and the metal complex used as a catalyst is zerovalent.

A metal complex that is not zerovalent is reduced for use by placing another metal in the reaction system. A zerovalent metal complex sometimes react with oxygen or water in air, thus failing to provide sufficient catalyst activity. Therefore, it is an ordinary practice to weigh the metal complex within a glove box and to perform the polymerization reaction thereof in an inert gas. As for commercially available solvents, dehydration thereof may sometimes be insured, but the dissolved oxygen concentration is ordinarily not insured. A reason for the dramatic enhancement in the molecular weight through the use of a deoxygenated solvent is considered to be that a subsidiary reaction caused by the coordination of solvent-dissolved oxygen to the catalyst (oxidation of the catalyst) is restrained.

The methods of making an electrolyte polymer insoluble include a method in which a hydrophilic-hydrophobic block copolymer is synthesized, and a method in which a cross-linked structure is introduced through the use of a cross-linking agent or radiation. The electrolyte polymer is made insoluble by the hydrophilic-hydrophobic block copolymerization because hydrophobic portions aggregate within a polymer or among polymers. However, both the related-art method in which a hydrophilic-hydrophobic block copolymer is synthesized, and the method in which chemical crosslink is introduced need at least two steps, and therefore are disadvantageous in cost. The method in which crosslinking is formed through the use of radiation requires a special device, and furthermore, involves partial destruction of the polymer, giving rise to a risk of reducing the mechanical strength of the membrane.

However, according to the invention, if at least three species of monomers D, E, F that satisfy specific conditions are caused to undergo coupling polymerization, the resultant polymer possesses remarkably improved swelling resistance. This is considered to be because the reaction rate of the monomer D (or E), which is a hydrophobic monomer, and the monomer E (or D) is faster than the reaction rate of the monomer F, which is hydrophilic monomer, and the monomer E (or D), the reaction between the monomer E and the monomer D preferentially progresses, so that hydrophobic portions are introduced into the polymer in a block-like fashion.

### Examples 1 to 4, Comparative Example 1

### 1. Synthesis of Monomer

### 1.1. Synthesis of 2,5-dibromobiphenyl

480.0 g (1.91 mol) of 2,5-dibromoaniline, 306 mL of 35% hydrochloric acid, and 191 mL of water were added into a reaction container of 3 L, and then the heating and refluxing was performed for 20 minutes. After the reaction solution was cooled, a solution obtained by dissolving 144.0 g (2.06 mol) of sodium nitrite in 671 mL of water was dropped into the reaction solution over 40 minutes while the temperature thereof was maintained at 5° C. or lower. After the dropping, the reaction solution was stirred at the foregoing temperature for 20 min.

Next, 3360 g (43.0 mol) of benzene and 100 mL of water were added into 10 L of the reaction solution, which was then cooled to or below 10° C. This reaction solution was combined with the aforementioned solution. While the mixture was being stirred by a mechanical stirrer, a solution obtained by dissolving 612 g (7.46 mol) of sodium acetate in 1530 mL of water (cooled to or below 10° C.) was dropped to the mixture at or below 10° C. for 10 min. After that, the mixture was stirred at the foregoing temperature for 2 hours, and then was further stirred at room temperature for 42 hours. The reaction mixture was subjected to extraction with benzene. The extract was washed with water, washed with 3N—HCl, washed with water, washed with 10% KOH aqueous solution, washed with water, and then dried with anhydrous magnesium sulfate. The solvent was removed by evaporation, so that 265 g of a dark brown oil was obtained. This oil was distilled under reduced pressure to provide 252.1 g of an object substance at a yield of 42.3%. Furthermore, re-crystallization was performed twice with hexane, thus performing purification.

### 1.2. Synthesis of sodium 2,5-dibromobiphenyl-4′-sulfonate

### 1.2.1. Synthesis of 2,5-dibromobiphenyl-4′-sulfonic acid chloride

Under a nitrogen atmosphere, 240.85 g (0.77 mol) of 2,5-dibromobiphenyl and 1.2 L of dehydrated chloroform were placed in a 2-L reaction container, which was then cooled to or below 0° C. Then, 179.9 g (1.54 mol) of chlorosulfonic acid was dropped at or below 0° C. for 10 min. Then, after being stirred at the foregoing temperature for 2 hours, the mixture was poured onto 2 L of ice water. After neutralization with a 4N—NaOH aqueous solution, the solvent water were removed by evaporation to provide 510.7 g of a crude crystal of sodium 2,5-dibromobiphenyl-4-sulfonate. Next, 2.50 L of POCl₃ was added into a 4-L reaction container, 500 g of the crude crystal obtained as described above was added. After being stirred for 14 hours, the reaction liquid was filtered to remove impurities. The filtrate was concentrated to provide an object material in a crude form. The crude object material was purified by a silica gel column (hexane/ethyl acetate=50/1) to provide 109.5 g of the object material at a yield of 26.7%.

### 1.2.2. Conversion of Sulfonic Acid Chloride to Sodium Sulfonate

240 mL of ethanol and 4.06 g (0.0974 mol) of NaOH were placed in a 500-mL reaction container. A solution obtained by dissolving 19.8 g (0.048 mol) of 2,5-dibromobiphenyl-4′-sulfonic acid chloride in 60 mL of ethanol was dropped thereto, and the mixture was stirred at room temperature for 24 hours. After reaction, precipitated material was filtered, and was washed with ethanol, and was dried. Furthermore, the dried material was recrystallized from 240 mL of acetonitrile/water (=1/1 vol) to provide 13.9 g of the object material at a yield of 69.6%.

### 1.3. Synthesis of 2,5-dibromobiphenyl-4′-sulfonic acid (1,3-diethoxy-2-propanol) ester

Under a nitrogen atmosphere, 5.2 mL (33.3 mmol) of 1,3-diethoxy-2-propanol, 80 mL of dehydrated chloroform and 10.8 mL (0.13 mol) of dehydrated pyridine were added in a 300-mL reaction container, and a solution obtained by dissolving 14.6 g (35.6 mmol) of 2,5-dibromobiphenyl-4′-sulfonic acid chloride in 25 mL of dehydrated chloroform was dropped at room temperature, and the mixture was stirred for 17 hours. The reaction solution was heated and refluxed for 24 hours. Next, the solvent was removed by evaporation. Then, after purification through silica gel column (chloroform), the solvent was removed by evaporation to provide a yellow-brown oil. Since this oil contained unreacted 1,3-diethoxy-2-propanol, the 1,3-diethoxy-2-propanol was removed by evaporation at 90° C. and 6.5 mmHg to provide 3.2 g of an object material at a yield of 19%.

### 2. Synthesis of Polymer

### 2.1. Synthesis of (4,4′-biphenylene)[2,5-b]phenylene-4′-sulfonic acid (1,3-diethoxy-2-propanol) ester] Alternating Copolymer (Polymer 1)

Under a nitrogen atmosphere, 0.51 g (0.98 mmol) of 2,5-dibromobiphenyl-4′-sulfonic acid (1,3-diethoxy-2-propanol) ester, 0.37 g (0.98 mmol) of 4,4′-biphenyldiboronic acid (bis-neopentylglycol) ester, and 0.73 g (8.7 mmol) of sodium hydrogencarbonate, 7 mL of THF and 4 mL of water were added in a 10-mL Schlenk tube. 6.9 mg (6.0 μmol) of tetrakis(triphenyl)phosphine palladium and 1 mL of THF were added in another 10-mL Schlenk tube, and kept at 70° C. A monomer solution was added to the catalyst from a syringe to start the polymerization. After 12 days, the deposited polymer and the reaction material were poured into ethanol to perform reprecipitation, and the precipitate was water-washed. The washed material was dried in a vacuum at 60° C. for 12 hours to provide 0.38 g of an object compound at a yield of 78%.

### 2.2. Synthesis of (1,4-phenylene)[2,5-biphenylene-4′-sulfonic acid (1,3-diethoxy-2-propanol) ester] Alternating Copolymer (Polymer 2)

Polymerization similar to that in the synthesis of [2.1.] was performed, using 0.16 g (0.98 mmol) of 1,4-phenylene bisboronic acid instead of 4,4′-biphenyldiboronic acid (bis-neopentyl glycol) ester. 0.35 g of an object compound was obtained at a yield of 81%.

### 2,3. Synthesis of sodium (1,4-phenylene)(2,5-biphenylene-4′-sulfonate) Alternating Copolymer (Polymer 3)

Under a nitrogen atmosphere, 0.5 g (1.21 mmol) of sodium 2,5-dibromobiphenyl-4′-sulfonate, 0.20 g (1.21 mmol) of 1,4-phenylenebisboronic acid, 0.73 g (8.7 mmol) of sodium hydrogencarbonate, 19.5 mL of DMF, and 12.8 mL of water were added in a 50-mL two-neck flask. 6.9 mg (6.0 μmol) of tetrakis(triphenylphosphine)palladium, and 1 mL of DMF were added in another 10-mL Schlenk tube, and kept at 90° C. A monomer solution was added to the catalyst from a syringe to start the polymerization. After 2 days, the precipitated polymer and the reaction material were poured into ethanol to perform reprecipitation, and the precipitate was water-washed. The washed material was dried in a vacuum at 60° C. for 12 hours to provide 0.26 g of an object compound at a yield of 65%.

### 2.4. Synthesis of (1,4-phenylene)(2,5-biphenylene) Copolymer (Polymer 4)

Under a nitrogen atmosphere, 0.37 g (1.20 mmol) of 2,5-dibromobiphenyl, 0.28 g (1.20 mmol) of 1,4-dibromobenzene, and 0.7 mL of THF were added in a 10-mL Schlenk tube. 0.12 g (0.19 mmol) of nickel dichlorodi(triphenylphosphine), 1.60 g (0.02 mol) of activated zinc, 0.72 g (2.81 mmol) of tetraethylammonium iodide, and 1 mL of THF were added in another 10-mL Schlenk tube, and kept at 70° C. A monomer solution was added to the catalyst to start the polymerization. After 20 hours, the precipitated polymer and the reaction material were poured into a 1N hydrochloric acid ethanol solution to perform reprecipitation. The precipitate was dried in a vacuum at 60° C. for 12 hours to provide 0.26 g of an object compound at a yield of 96%.

### 3. Making of Electrolyte

### 3.1. Electrolytes 0.1, 2 (Examples 1, 2)

Polymer 1 was dissolved in DMAc, and the solution was cast onto a glass dish of 2.5 mm in diameter. The solvent was then vaporized at polymer 1. The resultant membrane (34.2 mg) was placed in a separable container, and 2.7 mL of n-butanol and 7.8 mg of sodium hydroxide were added, and then were reacted for 2 days while the temperature was kept at 100° C. After being cooled to room temperature, the product was washed with methanol, and was dipped in 1N—HCl aqueous solution for 12 hours, and was washed with water to provide an electrolyte membrane made of Electrolyte 1. Likewise, Polymer 2 was subjected to a process similar to the foregoing process, to provide an electrolyte membrane made of Electrolyte 2.

### 3.2. Electrolyte 3 (Example 3)

Polymer 3 was dipped in 1N—HCl aqueous solution for 12 hours, and was washed with water. The washed material was dried in a vacuum at 60° C. for 12 hours to provide Electrolyte 3.

### 3.3. Electrolyte 4 (Example 4)

The resultant Polymer 4 (1 g) and 3 mL of 1,2-dichloroethane were place in a 10-mL Schlenk tube, and the temperature was kept at 0° C. Then, 0.029 mL (0.44 mmol) of chlorosulfonic acid was dropped, and the mixture was stirred at 0° C. for 2 hours, and then was stirred at room temperature for 24 hours. Water was poured to the reaction material to perform water washing. The washed material was dried in a vacuum at 60° C. for 12 hours to provide 0.062 g of Electrolyte 4.

Formulas (11) to (14) show reaction formulas of conversion from Polymers 1 to 4 into Electrolytes 1 to 4.

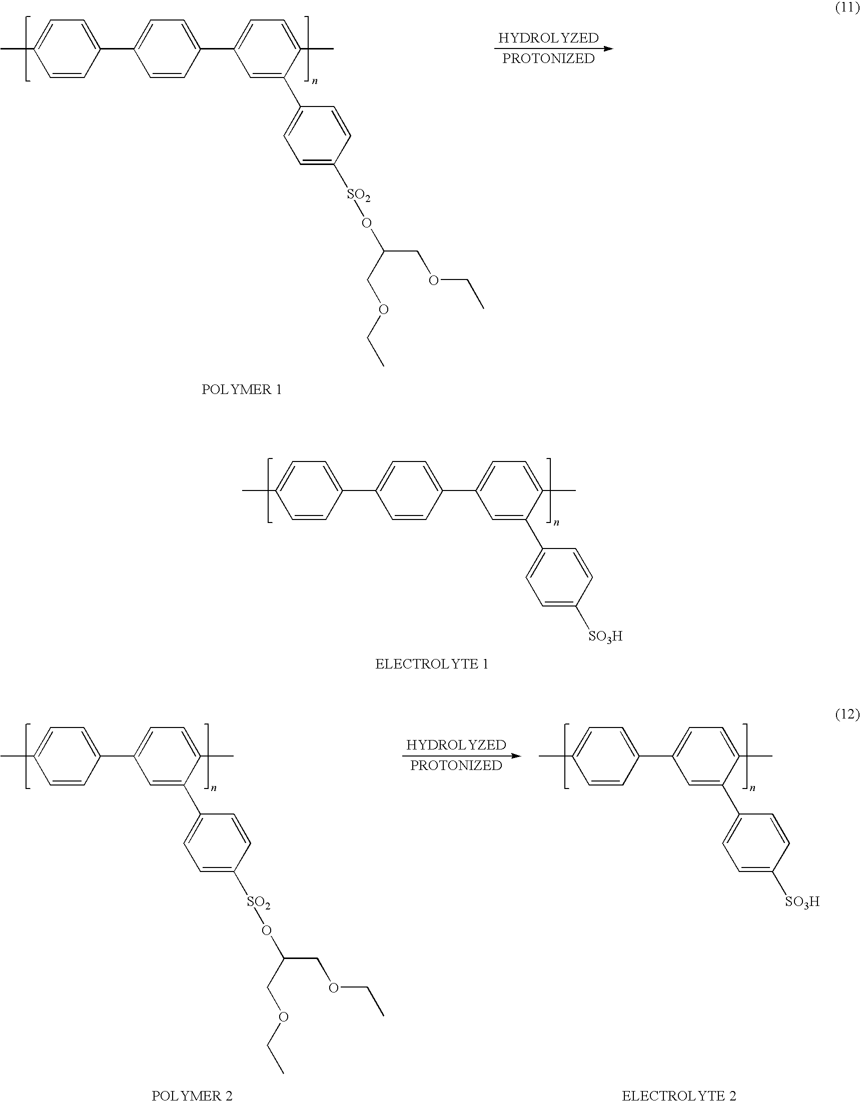

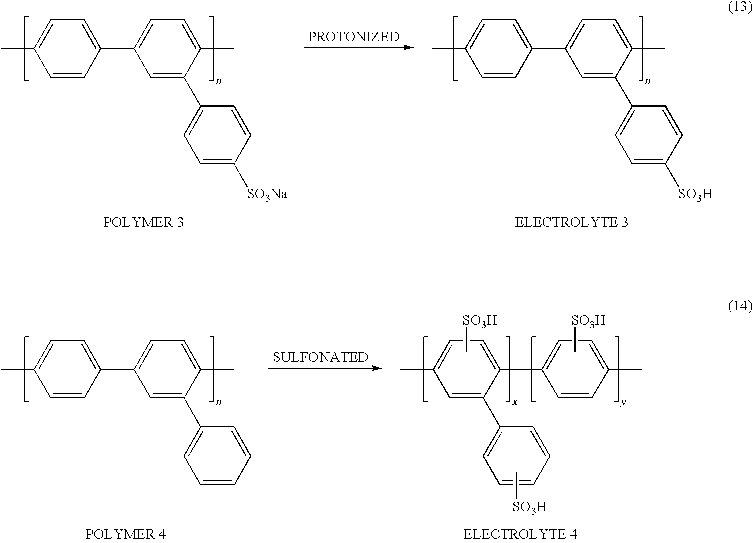

### 4. Evaluation (1)

### Membrane Physical Property of Electrolyte Membrane

[4.1. Test Method]

[4.1.1. Measurement of Water Content]

The resultant electrolyte membrane was dipped in water at room temperature, and the weight thereof was measured. This membrane was dried under a reduced pressure condition at 80° C. for 2 hours, and then the weight thereof was measured. The proportion of the water contained to the dry weight of the membrane was determined as the water content thereof.

[4.1.2. Measurement of Swelling Rate of Membrane]

After the resultant electrolyte membrane was dipped in water at room temperature, moisture was removed from the surfaces of the membrane, and the dimensions thereof in the planar direction and in the membrane thickness direction were measured. After this membrane was dried under a reduced pressure condition at 80° C. for 2 hours, the dimensions thereof in the planar direction and in the membrane thickness direction were measured. The proportion of the elongation of the membrane in a water-containing state to the dry membrane dimension was determined as swelling rate.

[4.1.3. Measurement of Conductivity]

The resultant electrolyte membranes were attached to conductivity measurement cells, and the resistance thereof in a planar direction in water at 25° C. was measured by an LCR meter. By converting the measured values, values of conductivity were obtained.

4.2. Results

With regard to the electrolyte membrane made of Electrolyte 1, various physical property values were measured according to the foregoing measurement methods. It turned out that the water content was 334%, and the conductivity was 0.041 S/cm (in water at 25° C.). Furthermore, the swelling rate in the planar direction was 5%, the swelling rate in the membrane thickness direction was 142%. Thus, the swelling rate in the planar direction was found to be remarkably smaller than that in the membrane thickness direction.

### 5. Evaluation (2)

### Molecular Weight Measurement

With regard to Electrolytes 1 to 4, molecular weight measurement was performed by SEC (DMSO containing 50 mmol/L LiBr). Using polystyrene as a standard, the number-average molecular weight (Mn), the weight-average molecular weight (Mw) and the molecular weight distribution (Mw/Mn) were found. Results are shown in v 1. From Table 1, it can be seen that Electrolytes 1 and 2 obtained by polymerizing the sulfonic acid ester monomer have higher molecular weights than the other electrolytes in terms of the number-average molecular weight.

| Example | Electrolyte | Mn | Mw | Mn/Mn |
|---|---|---|---|---|
| 1 | 1 | 1.32 × 10⁴ | 1.92 × 10⁵ | 14.6 |
| 2 | 2 | 1.19 × 10⁴ | 2.18 × 10⁴ | 1.83 |
| 3 | 3 | 4.45 × 10⁴ | 7.71 × 10³ | 1.73 |
| 4 | 4 | 5.98 × 10⁴ | 1.26 × 10⁴ | 2.10 |

### 6. Evaluation (3)

### Fenton Test

### 6.1. Synthesis of S-PEEK (Comparative Example 1)

Poly(ether ether ketone) was sulfonated by adding thereto concentrated sulfuric acid and causing reaction at 30° C. for 96 hours (EW=386). Then, the mixture was poured into water and reprecipitation was performed. Water-washing was repeatedly performed until the supernatant became neutral. Then, the washed material was dried in a vacuum at 60° C. for 12 hours to provide sulfonated poly(ether ether ketone) (S-PEEK).

### 6.2. Test Methods

Electrolyte 2 was added to and dissolved in an aqueous solution having a hydrogen peroxide concentration of 0.3% while the aqueous solution was kept at 60° C. Next, iron chloride aqueous solution was added to the solution of Electrolyte 2 so that the concentration of Fe²⁺ in the solution became 4 ppm, and the reaction was allowed to progress for 2 hours. The mole amount of hydrogen peroxide was 1.5 times the amount of the monomer unit. After that, an aqueous solution containing ruthenium ions was added so that the unreacted hydrogen peroxide was consumed. With regard to the polymer obtained through concentration of this solution, the molecular weight was measured by SEC (DMSO containing 50 mmol/L LiBr). For comparison, substantially the same experiment was performed with regard to the S-PEEK, and the reduction in molecular weight was evaluated. Results are shown in Table 2. From Table 2, it can be seen that Electrolyte 2 exhibited a smaller reduction in molecular weight reduction and is therefore higher in chemical durability than S-PEEK. Incidentally, in Table 2, “Molecular weight retention (%)” means (the post-Fenton test molecular weight of the electrolyte)×100/(the pre-Fenton test molecular weight of the electrolyte).

| | | | | | | | Molecular weight |
|---|---|---|---|---|---|---|---|
| | Before Fenton test | | | After Fenton test | | | retention (%) |
| | Mn | Mw | Mw/Mn | Mn | Mw | Mw/Mn | Mw |
| S-PEEK | 1.83 × 10⁵ | 4.70 × 10⁵ | 2.57 | 1.40 × 10⁵ | 3.38 × 10⁵ | 2.42 | 72 |
| Electrolyte 2 | 1.19 × 10⁴ | 2.18 × 10⁴ | 1.83 | 1.05 × 10⁴ | 1.98 × 10⁴ | 1.88 | 91 |

### Example 5

An aqueous solution containing 2.6 equivalent weights of H₂O₂ with respect to the mole numbers of the various model compounds was prepared so as to achieve the following concentrations in the reaction system: 0.6% of H₂O₂, and 10 ppm of Fe²⁺ ions, and reaction was allowed to progress at 80° C. for 24 hours. After the reaction, the retention rate and the aromatic ring retention rate were measured, using the integral value of 1H NMR.

Incidentally, the “retention rate (%)” means (the mole number of the compound remaining non-decomposed after the Fenton test)×100/(the mole number of the compound before the Fenton test). The “aromatic ring retention rate (%)” means (the mole number of the aromatic rings remaining non-decomposed after the Fenton test)×100/(the mole number of the aromatic rings before the Fenton test). However, the mole number of the aromatic rings remaining non-decomposed after the Fenton test does not include the aromatic rings of the compound remaining non-decomposed.

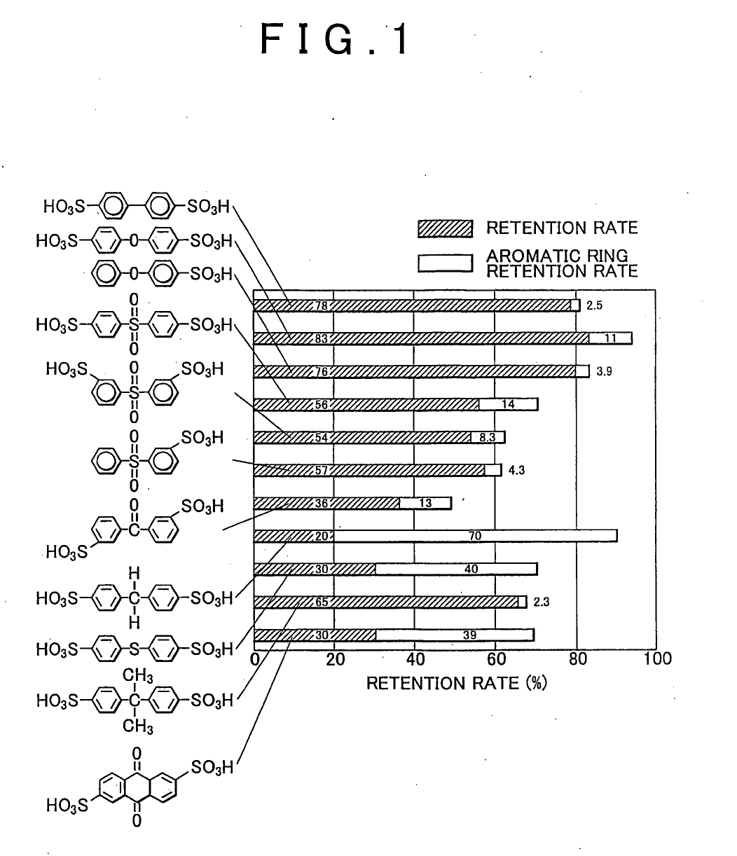

Results are shown in FIG. 1. From FIG. 1, it can be seen that the model compounds whose aromatic rings are bound via direct bonds or —O— bonds are higher in the retention rate than the other compounds. These results accord well with the results shown in Table 2.

### Examples 6 to 10

### 1. Monomer Synthesis

Following substantially the same procedure as in Example 1, 2,5-dibromobiphenyl-4′-sulfonic acid (1,3-diethoxy-2-propanol) ester was synthesized.

### 2. Deairing of Solvent

As for the THF and the water (ultrapure water) used the polymerization catalyst, oxygen was removed by the following two methods.

[2.1. Bubbling]

Under a nitrogen atmosphere, commercially available dehydrated THF or water was added into a recovery flask with a three-way cock attached. A needle connected to a N₂ line was inserted into the three-way cock, and the needle tip was introduced into the solvent contained in the recovery flask to perform bubbling for 30 min.

[2.2. Freeze-Deairing Method]

Under a nitrogen atmosphere, commercially available THF or water was added into a recovery flask with a three-way cock attached. After the three-way cock was closed, the recovery flask was cooled by liquid nitrogen to freeze the solvent. Then, the three-way cock was opened, and the flask was evacuated sufficiently to a vacuum while the solvent remained frozen. After the three-way cock was closed again, the flask was returned to room temperature to melt the solvent. This freezing-melting process was performed three times in total.

### 3. Polymer Synthesis

Under a nitrogen atmosphere, 0.48 g (0.92 mmol) of 2,5-dibromobiphenyl-4′-sulfonic acid (1,3-diethoxy-2-propanol) ester, and 0.35 g (0.92 mmol) of commercially available 4,4′-biphenylene-bis(boronic acid neopentyl alcohol ester) were added into a 25-mL two-neck pear flask, and 5 mL of THF deoxygenated by bubbling was added and dissolved therein to provide a monomer solution. 0.51 g (5.2 eq.) of Na₂CO₃ was added into a 25-mL test tube for an organic synthesis device (CCX-1010 of Zodiac), and 0.0213 g (0.01 eq.) of tetrakis(triphenylphosphine)palladium (0) (Pd(PPh₃)₄), i.e., a catalyst, was added thereto under an Ar atmosphere within a glove box, and then the atmosphere was substituted with a nitrogen atmosphere. Then, 2 mL of deoxygenated THF was added. While the test tube was kept at 65° C., the aforementioned monomer solution was added from a syringe, and 4 mL of deoxygenated water was added. While the temperature of 65° C. was maintained, the mixture was stirred for 12 days. After that, the test tube was returned to room temperature, and reprecipitation from 1N hydrochloric acid/ethanol was performed, and then purification by washing it with ethanol and then water was performed (Example 6).

Then, Na₂CO₃ was added as a base, and a polymer was synthesized in substantially the same manner as in Example 6, except that 0.40 g (5.2 eq.) of NaHCO₃ was used (Example 7).

Furthermore, another polymer was synthesized in substantially the same manner as in Example 6, except that a solvent deoxygenated through the use of a freeze-deairing method instead of the bubbling method was used (Example 8). Furthermore, a polymer was synthesized in substantially the same manner as in Example 8, except that 0.40 g (5.2 eq.) of NaHCO₃, instead of Na₂CO₃, was used as a base (Example 9). Furthermore, a polymer was synthesized in substantially the same manner as in Example 7, except that instead of a deoxygenated solvent, a non-deoxygenated solvent was used (Example 10).

### 4. Test Method

[4.1. Molecular Weight Evaluation]

The molecular weight measurement was performed using a column made by Tosoh (TSK-GEL α-M), a UV detector made by GL Sciences (UV620), a pump (PU610), and DMSO (50 mmol/L LiBr, 0.5 mL/min flow rate) as an eluent. Using polystyrene as a standard, the number-average molecular weight (Mn), the weight-average molecular weight (Mw), and the molecular weight distribution (Mw/Mn) were found.

[4.2. Membrane Formability]

Each of the polymers synthesized in Examples 6 to 10 was dissolved in DMAc. Then, this was cast onto a polytetrafluoroethylene dish, and the DMAc was vaporized at room temperature. The resultant membrane and 2.5 eq. of NaOH with respect to the membrane were heated at 100° C. overnight in n-BuOH. After that, the membrane was washed with EtOH, and then conversion into sulfonic acid in 1N HCl aqueous solution. After water washing, the material was dried to provide an electrolyte membrane. Each of the thus-made membranes was bent to 180°. If a membrane did not crack, its membrane formability was evaluated as good. If a membrane cracked, its membrane formability was evaluated as no good.

### 5. Results

Results are shown in Table 3 below. The molecular weight of each of the polymers (Examples 6 to 9) synthesized through the use of a deaired solvent was 100 thousand or higher, while the molecular weight of the polymer (Example 10) synthesized through the use of a non-deaired solvent was about 10 thousand. The electrolytes having a high molecular weight of 100 thousand or higher were good in membrane formability, and are considered to be applicable as electrolyte membranes of fuel cells.

| | Deair- | | | | | | Membrane |
|---|---|---|---|---|---|---|---|
| | ing | | Yield | Mn | Mw | Mn/ | formabil- |
| Examle | method | Base | (%) | (10⁴) | (10⁴) | Mn | ity |
| 6 | Bubbling | NaHCO₃ | 88 | 1.32 | 1.92 | 14.6 | Good |
| 7 | Bubbling | NaHCO₃ | 92 | 1.19 | 2.18 | 1.83 | Good |
| 8 | Freezing | NaHCO₃ | 97 | 4.45 | 7.71 | 1.73 | Good |
| 9 | Freezing | NaHCO₃ | 100 | 5.98 | 1.26 | 2.10 | Good |
| 10 | None | NaHCO₃ | 90 | 5.98 | 1.26 | 2.10 | No good |

### Examples 11 to 15

### 1. Monomer Synthesis

Following substantially the same procedure as in Example 1, 2,5-dibromobiphenyl-4′-sulfonic acid (1,3-diethoxy-2-propanol) ester was synthesized.

### 2. Deairing of Solvent

Using a freeze-deairing method, oxygen was removed from the THF and the water (ultrapure water) used for the polymerization catalyst.

### 3. Polymer Synthesis

Under a nitrogen atmosphere, 0.48 g (0.92 mmol) of 2,5-dibromobiphenyl-4′-sulfonic acid (1,3-diethoxy-2-propanol) ester (monomer F), and 0.35 g (0.92 mmol) of commercially available 4,4′-biphenylene-bis(boronic acid neopentyl alcohol ester) (monomer E) were added into a 25-mL two-neck pear flask, and 5 mL of THF deoxygenated by a freeze-deairing method was added and dissolved therein to provide a monomer solution. 0.51 g (5.2 eq.) of Na₂CO₃ was added into a 25-mL test tube for an organic synthesis device (CCX-1010 of Zodiac), and 0.0213 g (0.01 eq.) of tetrakis(triphenylphosphine)palladium (0) (Pd(PPh₃)₄), i.e., a catalyst, was added thereto under an Ar atmosphere within a glove box, and then the atmosphere was substituted with a nitrogen atmosphere. Then, 2 mL of deoxygenated THF was added. While the test tube was kept at 65° C., the aforementioned monomer solution was added from a syringe, and 4 mL of deoxygenated water was added. While the temperature of 65° C. was maintained, the mixture was stirred for 12 days. After that, the test tube was returned to room temperature, and reprecipitation from 1N hydrochloric acid/ethanol was performed, and then purification by washing it with ethanol and then water was performed (Example 11).

The synthesis of three-component monomers was performed (Examples 12 to 15) in substantially the same manner as in Example 11, except that while the amount of the monomer E remained the same, a total of 0.92 mmol of the monomer F and 1,4-dibromophenyl(monomer D) was used instead of 0.92 mmol of the monomer F

The Ratios of the Monomers were:

monomer D:monomer E:monomer F=5:50:45 (molar ratio) (Example 12);

monomer D:monomer E:monomer F=10:50:40 (molar ratio) (Example 13);

monomer D:monomer E:monomer F=20:50:30 (molar ratio) (Example 14); and

monomer D:monomer E:monomer F=30:50:20 (molar ratio) (Example 15).

### 4. Test Method

[4.1. Molecular Weight Evaluation]

The molecular weight measurement was performed using a column made by Tosoh (TSK-GEL α-M), a UV detector made by GL Sciences (UV620), a pump (PU610), and DMSO (50 mmol/L LiBr, 0.5 mL/min flow rate) as an eluent. Using polystyrene as a standard, the number-average molecular weight (Mn), the weight-average molecular weight (Mw), and the molecular weight distribution (Mw/Mn) were found.

[4.2. Membrane Formability]

Each of the polymers synthesized in Examples 6 to 10 was dissolved in DMAc. Then, this was cast onto a polytetrafluoroethylene dish, and the DMAc was vaporized at room temperature. The resultant membrane and 2.5 0 eq. of NaOH with respect to the membrane were heated at 100° C. overnight in n-BuOH. After that, the membrane was washed with EtOH, and then conversion into sulfonic acid in 1N HCl aqueous solution. After water washing, the material was dried to provide an electrolyte membrane of a proton material. Each of the thus-made membranes was bent to 180. If a membrane did not crack, its membrane formability was evaluated as good. If a membrane cracked, its membrane formability was evaluated as no good. The portion remaining non-dissolved was converted into a proton material by substantially the same method as described above, while the portion was in a powder form.

[4.3. Hot Water Resistance Test of Proton Material]

The electrolyte membranes of a proton material or the electrolytes of a powder form were dipped in hot water of 80° C. to investigate the solubility thereof.

[4.4. Conductivity Measurement]

The resultant electrolyte membranes were attached to conductivity measurement cells, and the resistances thereof in the planar direction at various humidities were measured by an ICR meter (by HIOKI). By converting the measured values, values of conductivity were obtained.

### 5. Results

Results are shown in Table 4 below. In the hot water resistance test, the two-component-based proton material membrane (Example 11) dissolved, but the three-component-based proton materials (Examples 12 to 15) were successfully made insoluble. In Example 12, since the addition of as little as 5 mol % of the monomer E made the electrolyte membrane insoluble, it is considered that a specific structure of one kind or another is formed in the main chain.

The monomer E is less in steric hindrance than the monomer F. In the monomer F, 4-sulfonic acid ester-benzene is bonded to the 2-position of 1,4-dibromophenyl, and therefore 1,4-dibromophenyl is inactivated. Thus, the structure of the monomer F is disadvantageous in the coordination to a metal complex. Therefore, the reactivity is expected to be higher in the monomer E than in the monomer F. Therefore, it can be inferred that hydrophobic blocks are formed by the monomers E.

| | | | | | | | | | Hot water |
|---|---|---|---|---|---|---|---|---|---|
| | Monomer | EW | Yield | Mn | Mw | | | Membrane | resistance |
| Example | D:E:F(mol %) | (g/eq.) | (%) | (10⁴) | (10⁴) | Mn/Mn | Solubility | formability | test |
| 11 | 0:50:50 | 385 | 97 | 39.7 | 211 | 5.4 | Soluble | Good | Dissolved |
| 12 | 5:50:45 | 410 | to 100 | Not | Soluble | Good | Insoluble | | |
| | | | | measurable | | | | | |
| 13 | 10:50:40 | 442 | to 100 | | | | Insoluble | No good | Insoluble |
| 14 | 20:50:30 | 537 | to 100 | | | | Insoluble | No good | Insoluble |
| 15 | 30:50:20 | 727 | 95 | | | | Insoluble | No good | Insoluble |

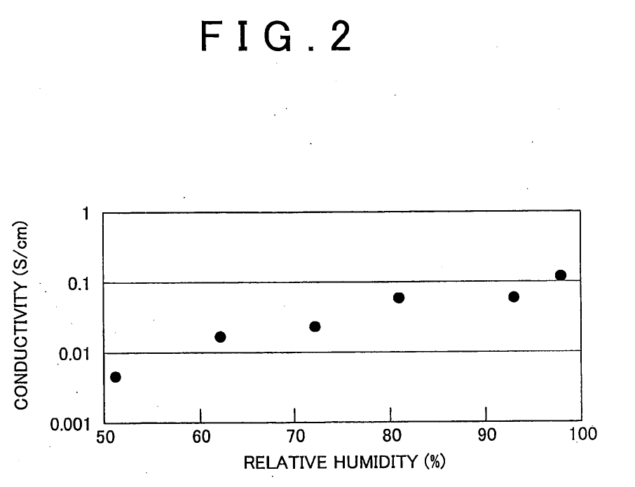

FIG. 2 shows the electric conductivity of a proton material membrane obtained in Example 12. From FIG. 2, it can be seen that the proton material membrane obtained in Example 12 is relatively high in electric conductivity. The aforementioned results show that the adoption of the three-component proton material allows a one-step synthesis of an electrolyte that satisfies both the high hot water resistance requirement and the high proton conductivity requirement.

While the embodiments of the invention have been described above in detail, the invention is not limited in any manner by the foregoing embodiments, but may be modified in various manners without departing from the sprit of the invention.

The polyparaphenylene hydrocarbon electrolyte and the manufacture method therefor in accordance with the invention can be used as an electrolytic membrane and a catalyst-layer-contained electrolyte for use in various electrochemical devices, such as solid polymer fuel cells, water electrolyzer devices, halogen acid electrolyzer devices, brine electrolyzer devices, oxygen- and/or -hydrogen concentraters, temperature sensors, gas sensors, etc. and can also be used as the manufacturing method therefor.

1. A hydrocarbon electrolyte comprising a polyparaphenylene having a structure represented by a formula (1): 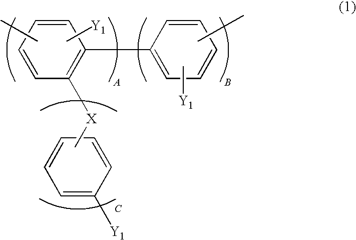
wherein A is an integer of 1 or greater; B is an integer of 0 or greater; C is an integer of 1 to 10; X represents a direct bond or an oxygen atom, which is arbitrarily assignable in repetitions; at least one of Y₁s represents a proton-conducting site, and a rest of Y₁s represents a hydrogen atom or a proton-conducting site, which is arbitrarily assignable in repetitions; and the proton-conducting site being made up of —SO₃H, —COOH, —PO₃H₂ or —SO₂NHSO₂R(R is an alkyl chain or a perfluoroalkyl chain).

2. The hydrocarbon electrolyte according to claim 1, wherein a proportion of para bonds in a main chain of the polyparaphenylene is 76 to 100%.

3. The hydrocarbon electrolyte according to claim 1 or 2, wherein a number average molecular weight of the polyparaphenylene is 5 thousands to 5 millions.

4. The hydrocarbon electrolyte according to any one of claims 1 to 3, wherein an ion exchange capacity of the polyparaphenylene is 0.1 to 4.5 meq/g.

5. A hydrocarbon electrolyte comprising a polyparaphenylene having a structure represented by a formula (2): 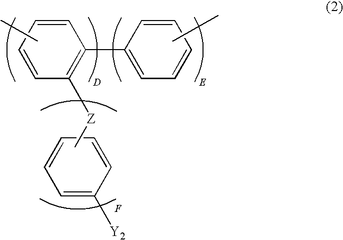
wherein D is an integer of 1 or greater; E is an integer of 0 or greater; F is an integer of 1 to 10; Z represents a direct bond or an oxygen atom, which is arbitrarily assignable in repetitions; and Y₂ represents a proton-conducting site made up of —SO₃H, —COOH, —PO₃H₂ or —SO₂NHSO₂R(R is an alkyl chain or a perfluoroalkyl chain).

6. The hydrocarbon electrolyte according to claim 5, wherein a proportion of para bonds in a main chain of the polyparaphenylene is 76 to 100%.

7. The hydrocarbon electrolyte according to claim 5 or 6, wherein a number average molecular weight of the polyparaphenylene is 5 thousands to 5 millions.

8. The hydrocarbon electrolyte according to any one of claims 5 to 7, wherein an ion exchange capacity of the polyparaphenylene is 0.1 to 4.5 meq/g.

9. A polyparaphenylene hydrocarbon electrolyte obtained by:
performing coupling-polymerization of at least one species of monomer D represented by a formula (8), at least one species of monomer E represented by a formula (9), and at least one species of monomer F represented by a formula (10) through a use of a catalyst containing a transition metal; and
converting a proton-conducting site precursor (Y₃) contained in a polymer obtained through the coupling polymerization into a proton-conducting site (Y₂). 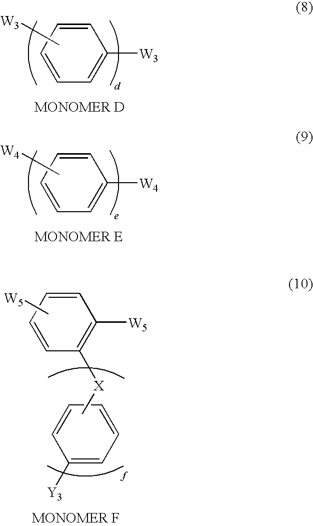
wherein d, e and f each are an integer of 1 to 10; X represents a direct bond or an oxygen atom, which is arbitrarily assignable in repetitions; Y₃ represents —SO₃R₁, —COOR₁, —PO(OR₁)₂, or —SO₂NHSO₂R₂; R₁ represents an alkali metal, an alkaline earth metal, quaternary ammonium or an alkyl group; R₂ represents an alkyl chain or a perfluoroalkyl chain; W₃ represents a halogen; W₄ represents a boronic acid or a boronic acid cyclic ester; and W₅ is the same as W₃ or W₄.

10. The hydrocarbon electrolyte according to claim 9, wherein the alkyl group includes a heteroatom.

11. The hydrocarbon electrolyte according to claim 9 or 10, wherein a proportion of para bonds in a main chain of the polyparaphenylene is 76 to 100%.

12. The hydrocarbon electrolyte according to any one of claims 9 to 11, wherein the number average molecular weight of the polyparaphenylene is 5 thousands to 5 millions.

13. The hydrocarbon electrolyte according to any one of claims 9 to 12, wherein an ion exchange capacity of the polyparaphenylene is 0.1 to 4.5 meq/g.

14. An electrolyte membrane comprising the hydrocarbon electrolyte according to any one of claims 1 to 13.

15. The electrolyte membrane according to claim 14, wherein a swelling rate of the membrane in a planar direction, which is a proportion of elongation of the membrane in a water-containing state to a dry membrane dimension, is 10% or less.

16. A catalyst layer comprising the hydrocarbon electrolyte according to any one of claims 1 to 13.

17. A solid polymer fuel cell wherein an electrolyte membrane and/or a catalyst layer constituting a membrane-electrode assembly contains the hydrocarbon electrolyte according to any one of claims 1 to 13.

18. A polyparaphenylene comprising a structure represented by a formula (3): 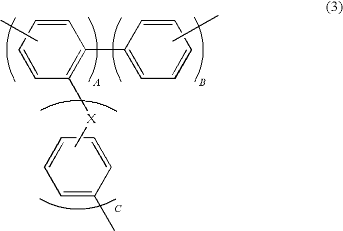
wherein A is an integer of 1 or greater; B is an integer of 0 or greater; C is an integer of 1 to 10; and X represents a direct bond or an oxygen atom, which is arbitrarily assignable in repetitions.

19. The polyparaphenylene according to claim 18, wherein a proportion of para bonds in a main chain of the polyparaphenylene is 76 to 100%.

20. The polyparaphenylene according to claim 18 or 19, wherein a number average molecular weight of the polyparaphenylene is 5 thousands to 5 millions.

21. A polyparaphenylene comprising a structure represented by a formula (4): 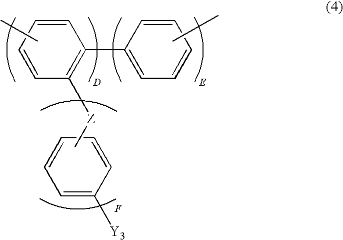
wherein D is an integer of 1 or greater; E is an integer of 0 or greater; F is an integer of 1 to 10; Z represents a direct bond or an oxygen atom, which is arbitrarily assignable in repetitions; Y₃ represents —SO₃R₁, —COOR₁, —PO(OR₁)₂ or —SO₂NHSO₂R₂; R₁ represents an alkali metal, an alkaline earth metal, quaternary ammonium or an alkyl group; and R₂ represents an alkyl chain or a perfluoroalkyl chain.

22. The hydrocarbon electrolyte according to claim 21, wherein the alkyl group includes a heteroatom.

23. The polyparaphenylene according to claim 21 or 22, wherein a proportion of para bonds in a main chain of the polyparaphenylene is 76 to 100%.

24. The polyparaphenylene according to any one of claims 21 to 23, wherein a number average molecular weight of the polyparaphenylene is 5 thousands to 5 millions.

25. A manufacture method for the hydrocarbon electrolyte according to any one of claims 1 to 12, comprising:
a polymerization step of performing a coupling polymerization of a monomer A shown by a formula (5) alone, or the monomer A and a monomer C shown by a formula (6) existing together, through a use of a catalyst containing a transition metal; and 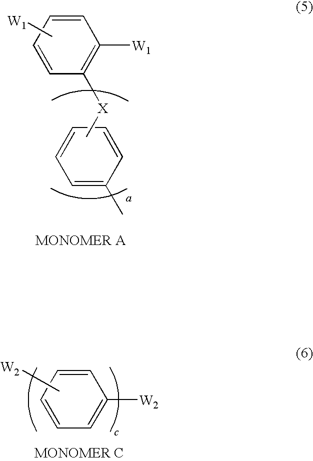
a proton-conducting site introduction step of introducing a proton-conducting site into any one or more of aromatic rings contained in a polymer obtained in the polymerization step and thereby obtaining a hydrocarbon electrolyte,
wherein a and c each are an integer of 1 to 10; X represents a direct bond or an oxygen atom, which is arbitrarily assignable in repetitions; and W₁ and W₂ each represent a halogen, a triflate (—OTf), a Grignard (—MgBr), a boronic acid or a boronic acid cyclic ester.

26. The manufacture method according to claim 23, wherein in the polymerization step, the coupling polymerization is performed through a use of a deoxygenated solvent.

27. The manufacture method according to claim 24, wherein the deoxygenated solvent is obtained by bubbling a pre-deoxygenation solvent with an inert gas.

28. The manufacture method according to claim 24, wherein the deoxygenated solvent is obtained by repeating, a plurality of times, an operation of freezing a pre-oxidation solvent in a container, and reducing pressure in the container, and then melting the solvent.

29. The manufacture method according to any one of claims 25 to 28, wherein the catalyst containing a transition metal is a transition metal complex.

30. The manufacture method according to claim 29, wherein a transition metal contained in the transition metal complex is at least one of Pd, Ni and Cu.

31. A manufacture method for the hydrocarbon electrolyte according to any one of claims 5 to 13, comprising:
a polymerization step of performing a coupling polymerization of a monomer B shown by a formula (7) alone, or the monomer B and a monomer C shown by a formula (6) existing together, through a use of a catalyst containing a transition metal; and 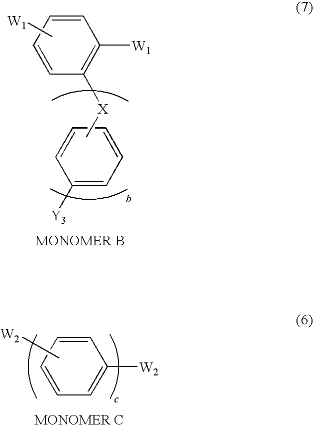
a proton-conducting site conversion step of converting a proton-conducting site precursor (Y₃) contained in a polymer obtained in the polymerization step into a proton-conducting site (Y₂) and thereby obtaining a hydrocarbon electrolyte, wherein b and c each are an integer of 1 to 10; X represents a direct bond or an oxygen atom, which is arbitrarily assignable in repetitions; Y₃ represents —SO₃R₁, —COOR₁, —PO(OR₁)₂ or —SO₂NHSO₂R₂; R₁ represents an alkali metal, an alkaline earth metal quaternary ammonium or an alkyl group; R₂ represents an alkyl chain or a perfluoroalkyl chain; and W₁ and W₂ each represent a halogen, a triflate (—OTf), a Grignard (—MgBr), a boronic acid or a boronic acid cyclic ester.

32. The hydrocarbon electrolyte according to claim 31, wherein the alkyl group includes a heteroatom.

33. The manufacture method according to claim 31 or 32, wherein in the polymerization step, the coupling polymerization is performed through a use of a deoxygenated solvent.

34. The manufacture method according to claim 33, wherein the deoxygenated solvent is obtained by bubbling a pre-deoxygenation solvent with an inert gas.

35. The manufacture method according to claim 33, wherein the deoxygenated solvent is obtained by repeating, a plurality of times, an operation of freezing a pre-deoxygenation solvent in a container, and reducing pressure in the container, and then melting the solvent.

36. The manufacture method according to any one of claims 31 to 35, wherein the catalyst containing a transition metal is a transition metal complex.

37. The manufacture method according to claim 36, wherein a transition metal contained in the transition metal complex is at least one of Pd, Ni and Cu.

38. A manufacture method for a polyparaphenylene hydrocarbon electrolyte, comprising:
a polymerization step of performing a coupling polymerization of at least one species of monomer D represented by a formula (8), at least one species of monomer E represented by a formula (9), and at least one species of monomer F represented by a formula (10), through a use of a catalyst containing a transition metal; and 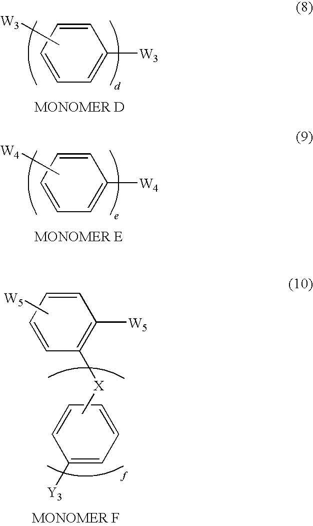
a proton-conducting site conversion step of converting a proton-conducting site precursor (Y₃) contained in a polymer obtained in the polymerization step into a proton-conducting site (Y₂),
wherein d, e and f each are an integer of 1 to 10; X represents a direct bond or an oxygen atom, which is arbitrarily assignable in repetitions; Y₃ represents —SO₃R₁, —PO(OR₁)₂ or —SO₂NHSO₂R₂; R₁ presents an alkali metal, an alkaline earth metal, quaternary ammonium or an alkyl group; R₂ represents an alkyl chain or a perfluoroalkyl chain; W₃ represents a halogen; W₄ represents a boronic acid or a boronic acid cyclic ester; and W₅ is the same as W₃ or W₄.

39. The hydrocarbon electrolyte according to claim 38, wherein the alkyl group includes a heteroatom.

40. The manufacture method according to claim 38 or 39, wherein in the polymerization step, the coupling polymerization is performed through a use of a deoxygenated solvent.

41. The manufacture method according to claim 40, wherein the deoxygenated solvent is obtained by bubbling a pre-deoxygenation solvent with an inert gas.

42. The manufacture method according to claim 40, wherein the deoxygenated solvent is obtained by repeating, a plurality of times, an operation of freezing a pre-oxidation solvent in a container, and reducing pressure in the container, and then melting the solvent.

43. The manufacture method according to any one of claims 38 to 42, wherein the catalyst containing a transition metal is a transition metal complex.

44. The manufacture method according to claim 43, wherein a transition metal contained in the transition metal complex is at least one of Pd, Ni and Cu.
